(19) United States
(12) Patent Application Publication
(10) Pub. No.: US 2003/0088536 A1
(43) Pub. Date: May 8, 2003

(54) Platform within an organization for providing knowledge management and decision support services

(76) Inventor: Afshin Behnia, West Hollywood, CA (US)

Correspondence Address: SONNENSCHEIN NATH & ROSENTHAL, Sears Tower, Wacker Drive Station, P.O. Box #61080, Chicago, IL, 60606-1080, US

(21) Appl. No.: 09/829,104

(22) Filed: Apr. 9, 2001

(51) Int. Cl. G06F 7/00

(52) U.S. Cl. 707/1

(57) ABSTRACT

An object-oriented method and system for managing a plurality of knowledge objects for use by an organization having a plurality of departments. The system includes a memory in which the knowledge objects can be stored. An application server is in communication with the memory and includes an object framework layer that provides management of communications with the memory. The object framework layer also communicates with other interface applications and devices, and manages sessions for the knowledge objects. The application server further includes a business logic layer defining functionalities of and interrelationships between the knowledge objects. An interface layer provides an interface for the interface applications and devices. The application server may further include an XML interface layer providing an XML interface for a plurality of further systems and a plurality of batch applications to communicate with the application server.

### FIELD

The present invention relates to providing knowledge management within an organization. More particularly, the present invention relates to a platform for sharing knowledge objects, including information and applications, within the organization.

### BACKGROUND

Knowledge is an important asset for organizations, especially in the information age. Successful organizations are often those that are able to access and use knowledge to accomplish their goals.

Modern organizations have various structures and arrangements of units, also referred to as departments, modules, groups or teams. Some organizations conform to a traditional business model, having units or departments arranged hierarchically. Others follow a distributed pattern, having specialized units or modules that generally operate on an even platform with one another. Still other organizations are hybrids, sharing aspects of both the hierarchical and distributed models.

Regardless of the particular structure of an organization or the nomenclature when describing organizational units, each unit generally has unique knowledge, including information and applications or processes. It is desirable that each unit have the means to leverage these “knowledge assets” to achieve its particular functions or goals. Further, it is desirable that other units in the organization be able to access and use the knowledge assets associated with a particular unit to maximize the efficiency and effectiveness of those other units. When sharing of knowledge assets is achieved in an efficient manner, the greatest value is added to the organization. The overall productivity of the company improves as the knowledge assets of the organization are disbursed and expanded. Thus, leveraging and managing the knowledge assets of the organization can be key to the overall success of that organization.

Some knowledge assets are maintained as documents within the organization. Such internal documents may be in physical and/or electronic form and include product specifications, customer lists, policies and procedures, among others. Other documented knowledge assets may be external to the organization yet easily accessible. Typical external documents include electronic information in off-site databases, archived documents, etc. Still other knowledge assets are contained in the minds of specific employees, or maintained by the collective intelligence of a unit of the organization. Examples of such knowledge assets include answers to questions regarding product and marketing strategies, reasons why customers buy, descriptions of best practices, new developments, whom to call, and where to find certain information. These knowledge assets are often fluid and in a state of flux and, thus, can have a significant impact on the performance of the entire organization. An important challenge for management, therefore, is to provide systems and facilities that support the efficient and effective sharing of such knowledge within the company.

Knowledge transfer is inherently chaotic. Knowledge can originate and be required from anywhere, by anybody, at anytime, and in any form. There is a continuing explosion in the volume of information available and the volume of information sources. While availability of information can initially be regarded as a good opportunity, the opportunity is lost if the volume of information expands beyond that which can be managed effectively. As information sources increase, the likelihood of any one source being used decreases. The velocity of change also effects both the currency and validity of the knowledge.

A number of organizational boundaries exist that contribute to the difficulties in managing the sharing of knowledge within the organization. The organization itself, whether structured hierarchically or in a distributed fashion, is inherently prohibitive of the sharing of knowledge. The units of an organization are generally defined by their respective functions or purposes and, thus, are somewhat independent of one another. For example, an insurance company may have a number of distinct units or departments including claims settlement, claims management, risk management, negligence assessment, and claims litigation. Each unit has its own unique data that serves the insurance company. In practice, however, the same knowledge is often desired by several of these units to accomplish their particular goals. Thus, when the knowledge is not shared, units within the organization are often left to “reinvent the wheel” on many occasions when such is completely unnecessary.

Organizational boundaries also contribute to difficulties in sharing applications within the organization. As with the distribution of data among units, particular applications or processes are maintained and used by the various units. In a typical insurance company, for example, such applications include calendar maintenance, expense tracking, department management, personnel management for various tasks and projects, rule tracking for internal rules (e.g., office policies and procedures) and external rules (e.g., court rules). Conventional products have been offered in an attempt to address some of these needs. These include office management applications, calendar applications, and word processing applications. These products fail, however, to take into account the organizational structure, particularly the overlapping needs of multiple units within the organization. Consequently, specialized applications are often maintained by units within an organization for the particular purposes of those units, but are neither available to nor integrated with the applications maintained by other units.

Object Oriented Technology or simply Object Technology, often abbreviated “OOT” or “OT”, has the potential to overcome the problems associated with development, maintenance, and extension of software applications within a company's information system and to provide interoperability and adaptability across multiple applications and hardware platforms. The three most popular object oriented programming languages are probably “JAVA”, “C++,” and “Smalltalk.” Object Oriented Technology involves a method for the development of operating software as well as application software for a computer system. Contrary to conventional, non-object oriented techniques of developing software, Object Oriented Technology comprises and uses preengineered “methods” and “objects” for the development of software. Object Oriented Technology provides a “class” as a kind of software template from which individual objects can be instantiated. These classes are usually stored in a software library or a so called “class library.” A class library is simply a collection of several classes stored together in a special filing format called a library.

In Object Oriented Technology, an object is a self-contained piece of software consisting of related data and procedures. “Data” means information or space in a computer program where information can be stored, e.g. a name or an inventory part number. Procedures are parts of a program that cause the computer to actually do something, e.g. the parts of a program that perform calculations or the part of a program that stores something on a computer disk. In Object Oriented Technology, an object's procedures are often called operations or “methods.” These procedures or methods can be invoked to manipulate the data. The methods are invoked on the object by sending calls to the object.

The concept that both data and methods are contained inside an object is called “encapsulation.” Part of the concept of encapsulation is that an object has a predictable way of communicating with other objects, a so called predictable “interface,” otherwise referred to as a “method contract.” Provided that the interface is not changed, the code or methods inside the object can be changed without disrupting other objects' ability to interact with that object. For example, a TAX CALCULATION object would have a predictable interface for use by PAYCHECK objects. Provided that interface will not be changed, the detailed program code inside the TAX CALCULATION object could be changed whenever the tax laws changed, and no other objects in the payroll system would have to know anything about such changes.

Each object has an object type that defines the operations that can be performed on objects of that type. One object type may inherit the object operations defined and implemented for other object types. In Object Oriented Technology the term “inheritance” refers to the concept that one object can inherit part of its behavior and data from another object, e.g. since an employee is a type of person, an EMPLOYEE object might inherit the characteristics of a PERSON object, such as having name, birth date, and address data, as well as an EMPLOYEE object might inherit methods for updating and displaying these data. Even if an object inherits some of its characteristics from other objects, that object can, and usually would, also have its own non-inherited characteristics, e.g. whereas a PERSON object would have an inheritable method to display a person's address, a PERSON object would probably not have a method for displaying paycheck history, since not all persons get paychecks. Because an EMPLOYEE object could not inherit this method from a PERSON object, an EMPLOYEE object would have to define its own method for displaying paycheck history. For further description of object oriented design and programming techniques see “Object-Oriented Software Construction” by Bertrand Meyer, Prentice-Hall 1988, which is incorporated herein by reference.

In object oriented distributed systems based upon the client-server model, there exist servers that provide object oriented interfaces to their clients. These servers support objects consisting of data and the associated software for manipulating the data according to the operations permitted by this type of object. Clients may obtain access to these objects and may execute calls on them by transmitting the calls to the server. At the server these calls are executed via the software associated with the object. The results of these calls are then transmitted back to the client.

Currently, a number of companies have agreed to standardize certain object definitions and interfaces to permit the sharing of such objects with one another. One system, designed to enable participation in such inter-company sharing of objects, is called Distributed Objects Environment (“DOE”), created by Sun Microsystems, Inc. Sun, Distributed Objects Environment, and Sun Microsystems. Inc. are trademarks or registered trademarks of Sun Microsystems, Inc., in the United States and other countries. Distributed Objects Environment is an object-oriented system, providing remote access from clients to DOE objects. Server applications implement DOE objects. For any given DOE object, a DOE server can create an object reference that acts as a pointer to the DOE object. A DOE object reference can be passed around between different processes on one machine or between different machines and it will still point to the original object. When a client application at one location obtains a DOE object reference, it can send calls (method invocation requests) to the target DOE object. The target DOE object can then execute these calls, possibly updating its internal state (its data) and possibly returning some results to its caller. As part of processing a method invocation, a server can itself invoke other objects, creating a chain of object invocations.

The concept of an object being a self-contained piece of software having data and procedures inside is a relatively new way of developing software. In non object oriented software, most of the data for an entire program is often grouped together near the beginning of the program, and the procedures then follow this common pool of data. This conventional method was satisfactory for smaller programs, but the growth and complexity of software has lead to increasing difficulty on the part of software developers to figure out which procedures are using which data in such programs. Thus, it has become difficult and expensive to debug and modify conventional software programs.

With Object Oriented Technology, it is generally easier to debug, maintain, and enhance object oriented software. Known graphical user interfaces provide application developers with an application program interface (API) that includes a collection of objects, such as scroll bars, push buttons, text entry fields and so forth. An object oriented graphical user interface (GUI) typically includes a hierarchical collection of these objects in a “toolkit”. The behavior of a graphical user interface within a system is defined by interactions between the objects in the client of a client/server environment and the window-based system server.

A paradigm used to represent defined interactions between the objects is often referred to as a “model-view-controller” (MVC) paradigm of object interaction. The model-view-controller paradigm formally defines the manner by which changes in state occur within at least part of the system (e.g., a timer of the system), and how those changes are to be communicated to, or reflected in, other parts of the system that have established an interest in observing such state changes (such as a displayed clock). The controller can be considered a set of rules which define how state changes implemented in response to a model will affect a view. Using the model-view-controller paradigm, the toolkit can be considered a hierarchical collection of models, views and controllers that implement the graphical user interface.

The definition of the relationships between models, views, and controllers is established by implementation-specific definitions of object classes. Although the relationships between particular instances of models, views and controllers can be dynamically specified during the lifetime of an application, these relationships are generally not alterable at the time of execution of a client-side application except through assignment between instances of particular implementations of the models and views. This is the case, for example, where object oriented systems are implemented in programming languages such as C++.

Many companies developing software applications are concerned about the cost and risks involved with the reworking of existing applications and with the construction of new applications using Object Oriented Technology. For those software application developers, a technical foundation for software applications has to be built as a tool using Object Oriented Technology as the basis, allowing each developer to develop unique software products. This technical foundation is formed by frameworks comprising the basic application structure which software application developers previously had to develop by themselves. In Object Oriented Technology, the term “framework” is used to describe a reusable set or collection of classes which work together to provide a commonly needed piece of functionality not provided by any of the individual classes inside the framework. Thus a framework defines a specific way in which multiple objects can be used together to perform one or more tasks which no single object performs. In other words, a framework is a reusable, predefined and preengineered bundle of several objects which address a recurring programming problem.

Frameworks provide a way of capturing a reusable relationship between objects, so that those objects do not have to be reassembled in that same relationship every time they are needed. Frameworks provide a way of grouping multiple objects together to perform some function which should not have to be thought through each time at the underlying object level. For example, a PRINT framework would consist of all the objects necessary for a programmer to easily print something on any printer, and would probably include objects for printer selection, spooling to disk or error detection as “out of paper”. Frameworks can be regarded as a group of software objects which contain a technical foundation for a software application.

For frameworks to be used to model organizations having multiple units, not only should the requirements of business processes be considered, but also the organizational structure itself be taken into account. Each unit within an organizational structure would desirably tailor the information it shares with other units and the information specific to itself. In an object oriented framework, knowledge objects would desirably be defined in such a way that they could be selectively shared among the units of an organization. This is difficult using conventional methods and systems because of the inherent barriers between units of an organization, as explained above. While the various units continue to use specialized applications for their respective purposes, conventional applications provide little, if any, integration between the units. Thus, information and applications are not available outside of a particular unit for others. The organization as a whole continues to be inefficient, needlessly wasting time and money within, and the original goal of using knowledge assets to maximize business value is lost.

### SUMMARY

One aspect of the present invention relates to an object-oriented method and system for managing a plurality of knowledge objects for use by an organization having a plurality of departments. The system includes a memory in which the knowledge objects can be stored. An application server is in communication with the memory and includes an object framework layer that provides management of communications with the memory. The object framework layer also communicates with other interface applications and devices, and manages sessions for the knowledge objects. The application server further includes a business logic layer defining functionalities of and interrelationships between the knowledge objects. An interface layer provides an interface for the interface aplications and devices. The application server may further include an XML interface layer providing an XML interface for a plurality of further systems and a plurality of batch applications to communicate with the application server.

### BRIEF DESCRIPTION OF THE FIGURES

FIG. 1 shows a hierarchical arrangement of knowledge classes and objects serving as a framework 100 for an organization, such as an insurance company, provided in accordance with an exemplary embodiment of the present invention;

FIG. 2 shows an exemplary system 200 for managing knowledge objects among a plurality of units within an organization, constructed in accordance with an exemplary embodiment of the present invention;

FIGS. 3A-26C show graphical user interfaces (“GUIs”) generated by methods performed in accordance with exemplary embodiments of the present invention; and

FIG. 27 shows a block diagram of a computer system 2700 constructed according to an exemplary embodiment of the present invention.

### DETAILED DESCRIPTION

This detailed description presents a platform which has an architecture including one or more computer systems or machines. Methods and operations on data bits are performed by the computer systems and/or machines, and are referred to herein with symbolic representations. These methods, descriptions, and representations are the means used by those skilled in the data processing arts to most effectively convey the substance of their work to others skilled in the art.

A method is here, and generally, described as a sequence of steps leading to a desired result. These steps include physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. All of these and similar terms are to be associated with the appropriate physical quantities and are merely convenient labels applied to these quantities.

Useful machines for performing the operations of the present invention include general purpose digital computers or similar devices. The general purpose computer may be selectively activated or reconfigured by a computer program stored in the computer. A special purpose computer may also be used to perform the operations of the present invention. In short, use of the methods described and suggested herein is not limited to a particular computer configuration.

The following terms are used throughout the detailed description and are generally defined as follows. The particular definitions will, of course, depend upon the context in which these terms are used.

Record

A record refers to a specific instance within an object. For example, John Henderson is a record within the object Contact. The information pertaining to John Henderson is specific to this particular record.

User

A User is a contact that can access and perform operations on Objects according to his/her security profile.

Main Menu Bar

A Main Menu Bar is the Users Menu Bar. The Main Menu Bar contains the objects a User has rights to work on.

Administrator Menu Bar

An Administrator Menu Bar contains Administrative Objects.

Command Buttons

A command button performs an action concerning an object.

Tabs

Tabs take the user to additional screens pertaining to an object.

Workspace

A Workspace generally includes a Data Entry Field where work can be done. Within this area users and administrators can enter, view, delete, and/or change data.

Objects

An exemplary platform constructed according to the present invention provides for a number of objects that perform different functions. The various objects include the following:

Projects

An object called “Project” allows a user to access and enter information related to matters, policies, and claims. Within Project, information is stored and organized in relating screens and tabs. Project serves as a central location where specific information relating to one particular matter, policy, claim, etc., can be stored.

Contacts

A “Contact” object generally represents a Person or a Company. A typical Contact has addresses, phone numbers, fax numbers, emails, internet addresses, and other information. Some Contacts also have Skills, Rates for different Tasks, and Territories in which they operate.

Appointments

An Appointment is a scheduled event with an Individual, such as a Meeting at a certain time and place. The Appointment can have one or more attendees. The Appointment is set to start and end at a specific time and date. Resources may be desired for the appointment, such as a conference room or a projector.

Tasks

A task is an action item. The Task can have specific start and end dates, depending on the desired implementation. Tasks can also have due dates.

History

History can be used to record actions that have taken place or status updates.

Expenses

Expense is designed to store information regarding the costs of activities. Such information varies from photocopy costs to travel and equipment. If desired, the expense records automatically post to an appropriate account.

Document

The Document object serves as a central location to store and access documents. It can also serve as a version control document manager. Using the document object, a user can attach any document and share the attached document with other users. The document object allows users to view, add, or modify the documents. The document object can also maintain a record of the versions and histories of a particular document file.

Document Generator

The Document Generator object provides the ability to generate documents, and merge information that already exists on various objects in the platform into a document.

Accounts

The Account object is designed to provide budget account and charge back account management. Child and parent relationships can be easily established for monitoring the appropriate budget configurations.

Invoices

The Invoice object is the point of entry of vendor related invoices. There are at least two views available for entering information on line items.

Preferences

Preferences allows for customizing the appearance of a Home Page and changing passwords. Preferences can be used to customize the platform to conform to the desired screen color, text size and color, etc.

Open Files

This section displays the File/Object Icons currently open.

Object/Menu

This refers to whether the object is a Project, Contact, Appointment, Task, Document, History, User, Group, etc. Clicking any of these menu options will provide a Popup Menu in which the user can make a selection.

Title Bar

The title bar will contain the Object Name as well as the Record Name. In one example, the Object Name is Appointment, while the Record Name is Training Session.

Popup Menu

The Popup Menu will popup when a user is prompted to make a selection.

Shortcut Buttons

These buttons will link to certain areas of the platform. For example, a “Home” button will link to a Home Page. A “Question Mark” button will link to Help. An “X” button will sign the user off from the platform.

Classes

Classes are made for the various objects, e.g., an account class, a policy class, a claim class, etc. Attributes of the classes are defined; for instance, a claim class includes date of incidence, the involved parties, the respective roles of those parties, and other information.

The classes are generally one of five different kinds of objects: Abstract, Lookup Tables, Main, Join and Administrative. Abstract Objects are the super classes from which all objects are derived. Lookup Table Objects pertain to the system tables. Main Objects pertain to the objects found in the Main Menu Bar (Contact, Project, Appointment, etc.). Join Objects are most of the tabs found in each object in the Main Menu (Skills, Territories, Assignees, etc.). Administrative Objects pertain to the objects found in the Administrative Menu Bar (User, Group, Application, etc.).

Most of the time, rules will be created for Main Objects. Most Main Objects have Join child objects attached to them.

Class Methods

Each class contains methods to create rules. Like class names, method names also have prefixes that often provide a good understanding of what action the method performs, for example:

“Get”

Read existing data.

“Add”

Add data.

“Remove”

Delete existing data.

“Set”

Set/Update the data.

Rules

Rules are classes added to the platform to automate desired repeatable changes, updates or actions to the application. A rule can be created to validate data, create new records, automatically populate fields, send e-mails, etc. Each object can have its own set of rules, and rules are executed in a desired order when saving a record or when selecting to run a rule within a record or both.

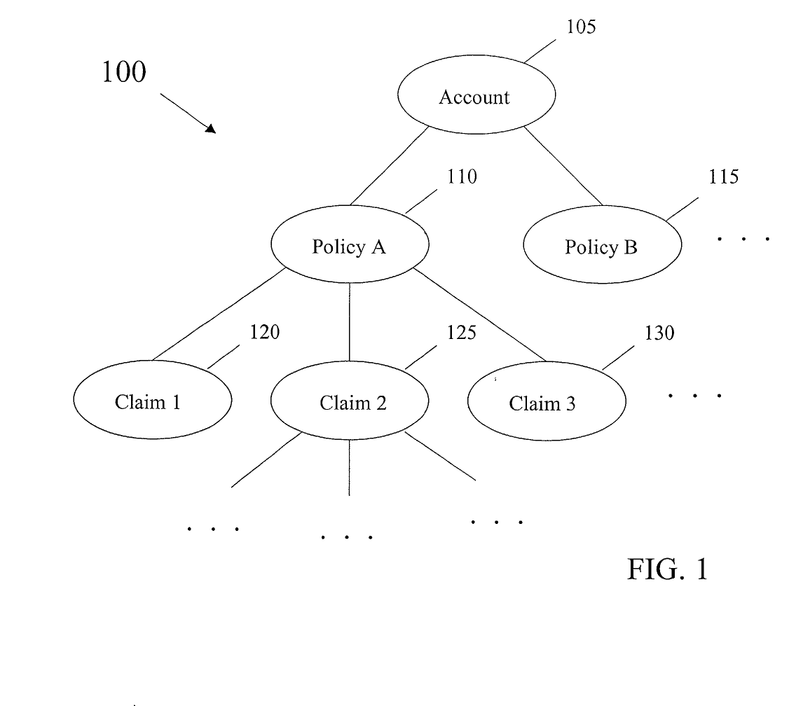

Knowledge objects in the platform generally have a hierarchical relationship. For example, in FIG. 1, a hierarchical framework is provided for knowledge objects to be used by an insurance company. The parent node is an account 105 associated with an individual. The account 105 is the parent to one or more policy classes, depending on the individual. In the example of FIG. 1, these classes include policy 110 (“Policy A”) and policy 115 (“Policy B”) Instances of these policy classes may be, for example, a home owner's insurance policy, and an automobile insurance policy, among others. One or more of the policies 110 or 115 can also be parents to a plurality of claims objects which are knowledge objects. As shown in FIG. 1, for example, policy 110 is the parent to claims objects 120, 125, and 130.

In FIG. 1, the parent-child relationships in the hierarchy are generally determined during the design phase. Some classes may be independent, while others are related to parents and/or children, as desired for the particular implementation. Each knowledge object can be created as a separate entity and freely customized to have a particular workflow, its own attributes, and other unique business rules as desired.

As mentioned above, the framework represented in FIG. 1 is only one example of many constructed according to exemplary embodiments of the present invention. In an alternative example, claims 120, 125, and 130 are classes rather than objects. One or more of the claims are parents to a plurality of other classes and/or objects. One such class is “legal matter.” This class enables the generation of legal matter objects representing litigation files for claims that are litigated. Other child classes of the claims classes include risk classes, described in greater detail below.

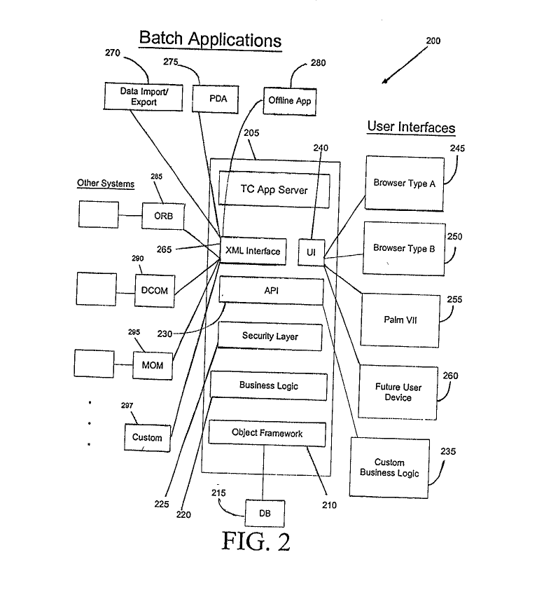

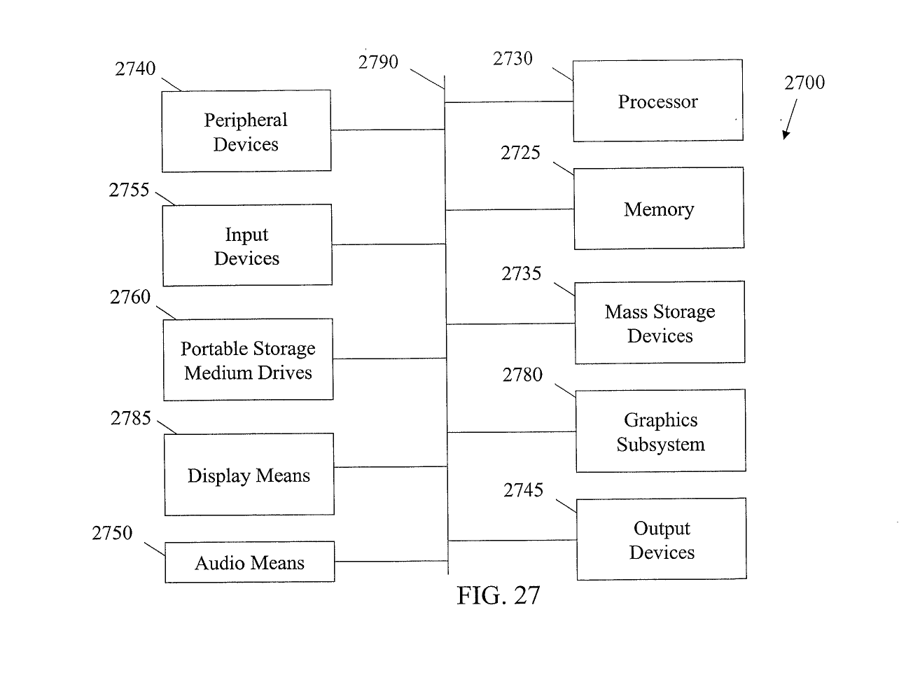

FIG. 2 shows an exemplary system 200 for managing knowledge objects among a plurality of departments within an organization, constructed in accordance with an exemplary embodiment of the present invention. The system includes an application server 205 which serves as an apparatus for sharing information. The application server 205 is generally constructed in accordance with the computer system 2700 of FIG. 27, described in greater detail below.

In FIG. 2, the application server 205 includes several layers. One of these is an object framework layer 210. This layer 210 serves as a basic infrastructure for the platform by providing relatively low-level management functions such as conducting transactions with a database 215, session management with browser applications and other interfaces, and communicating with instances of applications on other servers. The object framework layer 210 also maintains a cache of objects, and manages a session for each of the objects as the object pertains to individual users. This includes maintaining a list of object names, locating objects, and controlling access to the objects.

In FIG. 2, the application server 205 further includes a business logic layer 220. This layer 220 provides logic defining the functionality of and interrelationships between the knowledge objects. The business logic layer provides application frameworks, wherein some of the common knowledge objects are linked to other objects specific to the type of framework being built. The business logic layer provides a foundation for the behavior of various knowledge objects including the phases through which the knowledge objects pass during their life cycles.

Typical knowledge objects provided by business logic layer 220 include date and time, currency, address, units of measure, and calendar functions. The knowledge objects provided by layer 220 often serve as building blocks from which software application developers can select and create higher level business applications. These common objects can be copied and extended to perform new functions. For example, the date and time object can be extended to provide a Chinese calendar.

In FIG. 2, application server 205 further includes a security layer 225 that provides security for user and group accounts. The security layer 225 is fine-grained, as the layer 225 provides control over every action a particular user or group can perform on every object. There are essentially two sub-layers of the security layer 225. One is an access control layer that defines which users and what kind of users can perform which operations. To this end, the security layer 225 provides an access control list so the actions allowed by various users and groups can be specified. Typical actions include: view matter, change matter, delete matter, create claim, move claim between phases, and create appointment. The second sub-layer of the security layer 225 provides object-level security for specific instances. The instances can be restricted by who can read, modify, and delete the instance. For example, an object representing a sensitive legal matter can be marked as “private,” so the matter will not be read, modified or deleted.

In FIG. 2, the application server 205 further includes an application programming interface (“API”) layer 230 that can be used by an application developer to make executable code. The application developer generally accesses the API layer 230 using one or more graphical user interfaces for manipulating processes and data to define customized knowledge objects. These customized objects are stored in custom business logic 235. Exemplary graphical user interfaces for accessing the API layer 230 are described in greater detail below. Often, the customized business objects are applications which incorporate one or more common knowledge objects from business logic layer 220. In exemplary embodiments, the API layer 230 is exposed to the public via a data network such as the Internet. In this way, an individual client can access the application server and use the API layer to generate and tailor custom business objects and rules specific to the individual clients. Rules are made using classes and methods provided via the API layer 230, and are described in greater detail below.

In FIG. 2, the application server further includes a user interface layer 240 allowing users to access and interact with the API layer 230. The user interface layer 240 is configured to present a graphical user interface (“GUI”) to a user who connects to the application server 205, for example, via a data network such as the Internet or other communications means including wireless technologies. Exemplary graphical user interfaces which can be used to interact with application server 205 are described in greater detail below. To this end, a variety of devices can be used to communicate with application server 205, including a computer 245 on which a first browser can be executed (e.g., “Netscape”), and a computer 250 on which a second browser can be executed (e.g., “Internet Explorer,” by Microsoft Corp.). The application server 205 is compatible with various types of browser applications including some that are XML compatible and others that are non-XML compatible. Other suitable devices that can communicate with user interface 240 are a personal digital assistant (“PDA”), including those PDAs having mobile browser applications, such as the Palm VII by 3Com Corp. The user interface layer 240 can be configured to work in an “offline” mode with any of the aforementioned devices. The user interface layer 240 can be configured to interact with a future user device 260, as needed over time.

In FIG. 2, application server 205 also includes an XML interface 265. XML is a simplified, but strict subset of SGML (Standard Generalized Markup Language) The XML interface 265 generally serves as a system interface rather than a human interface. The application server 205 can be integrated with Other Systems, such as a policy application used by an insurance company, or Exchange 2000 by Microsoft Corp, using the XML interface 265. The other systems can then interact with application server 205 on a machine level. The interface 265 generally receives an XML document and calls an API method.

Using pre-defined tags and attributes, a document can be created to perform any of a variety of functions including: Data Import, Data Conversion, and others. The tags and attributes needed to create an XML document are defined in the XML schema, which documents all tags and attributes and gives an in-depth explanation of when, where and how they can be used.

In one example, a request to the application server through XML interface 265 is initiated with the following tag:

<PlatformRequest> . . . </PlatformRequest>

In FIG. 2, The XML layer 265 is used as an interface for batch applications, including Data Import/Export 270. The data import tool allows the application server 205 to import any design and configuration data (i.e. Tables, Fields, Forms and Applications) to an application. The data export tool allows the application server 205 to export design and configuration data (i.e. Tables, Fields, Forms and Applications) from the platform as an XML file through XML Interface 265. In addition, PDA batch application 275 allows the user to synchronize contacts and appointments maintained by the PDA with the platform. An off-line application 280 allows a user with a laptop to “check out” some documents and work on those documents in an off-line mode, also using the XML Interface layer 265.

The XML layer 265 also provides various methodologies allowing application server 205 to communicate with Other Systems including Object Request Broker (“ORB”) 285, Distributed Common Object Model (“DCOM”) 290, Message Oriented Middleware (“MOM”) 295, and other customized interfaces, represented as “Custom” 297. By these various means, the Other Systems can easily be integrated with application server 205.

Authentication

Regardless of whether XML Interface 265 or any of User Interfaces 245-260 are used to communicate with API layer 230, a user may be prompted to authenticate himself using an assigned username and password or the session ID:

<Username></Username>

<Password></Password>

<SessionID></SessionID>

The user can use the session ID tag once he has sent a request using his username and password. Once the request has been processed, the user will receive a response which contains the session ID. The user can then use this session ID to send requests to the platform.

After the authentication process, the user will be prompted to specify an entity or object available from the platform. The following is a list of exemplary entities and related tags.

| | |
|---|---|
| Account | <Account> . . . </Account> |
| Appointment | <Appointment> . . . </Appointment > |
| Contact | <Contact> . . . </Contact> |
| Document | < Document > . . . </Document> |
| Expense | <Expense> . . . </Expense> |
| History | <History> . . . </History> |
| Invoice | <Invoice> . . . </Invoice> |
| Involved | <Involved> . . . </Involved> |
| Milestone | <Milestone> . . . </Milestone> |
| Project | <Project> . . . </Project> |
| Task | <Task> . . . </Task> |

There are a number of different operations that can be performed for any of the above entities, including “insert,” “update,” “update/insert,” “delete” or “search.” These operations reflect the various methods provided by API 230. “Insert” reflects methods with the prefix set and add, “update” reflects methods with the prefix set, and “search” reflects methods with the prefix get.

Insert

The “insert” operation inserts a new record. This operation will be the only attribute for some objects, while other objects will require additional attributes aside from this operation.

<Entity op=“insert”>

Update, Update/Insert and Delete

The “update,” “update/insert,” and “delete” operations are used for existing records. To update, update/insert or delete an existing record, the XML layer 265 first conducts a search for existing records. Once a record is found, the XML layer 265 then performs the action. In order to find an existing record, search qualifiers are specified. The search qualifier is entered as an attribute in the Entity tag:

<Entity SearchQualifier=“” op=“update”>

<Entity SearchQualifier=“” op=“update/insert”>

<Entity SearchQualifier=“” op=“delete”/>

For example, John wants to update a contact. He knows that the social security number uniquely identifies each contact record; as a result, he uses the social security number as a search qualifier to find the record and update it.

<Contact SsOrTaxNumberString=“556-85-6321” op=“update”>

<Prefix>Mrs.</Prefix>

</Contact>

For “update,” only the information that needs to be updated should be included in the request. If information needs to be removed, the tag can be included with an empty string, as shown below.

<Contact SsOrTaxNumberString=“556-85-6321” op=“update”>

<Prefix>Mrs.</Prefix>

<MiddleName />

</Contact>

For “update/insert,” the XML layer 265 will first search for the record. If found, the record will be updated; otherwise it will be inserted.

For “delete,” only the entity, operation and search qualifier need be included. The entire record will then be deleted.

<Contact SsOrTaxNumberString=“556-85-6321” op=“delete” />

Complex tags also preferably include search qualifiers to update or delete information included in its sub tags. Just like entity, the search qualifier and the operation should be included as an attribute in the complex tag. Some complex tags include an attribute, which can be used as a search qualifier; those that do not can have the sub tag as an attribute.

The following example displays two varying complex tags: Address in which key is already an attribute and Rate which uses one of its sub tags TaskCategory as an attribute.

<Contact SsOrTaxNumberString=“625-84-1002” op=“update”>
<Address key=“BUS1” op=“update”>

<Street>26532 Ventura Boulevard Apt.

25</Street>

<City>Sherman Oaks</City>
<State>CA</State>
<PostalCode>93201</PostalCode>
<County>Los Angeles</County>
<Country>United States</Country>
<IsCurrent>1</IsCurrent>
<CurrentOn>2000-12-08</CurrentOn>
<ReferenceNumberString>32652</ReferenceNumberString>

</Address>
<Address key=“HOME” op=“delete” />
<Rate TaskCategory=“WBPD” op=“update”>

<EffectiveStartOn>2001-01-01</EffectiveStartOn>
<EffectiveEndOn>2001-12-31</EffectiveEndOn>
<RateAmount>$100.00</RateAmount>

</Rate>
</Contact>

Elements represent fields that have corresponding methods. There are generally two kinds of elements, simple and complex. Simple elements are single tags for which the data value is entered. Any method with the prefix “set” is a simple element.

| Method | Tag |
|---|---|
| setOpenedOn | <OpenedOn> . . . <OpenedOn> |
| ( ) | |

Complex elements on the other hand are those tags that require sub tags. Any method with the prefix “add” is a complex element.

| Method | Tag |
|---|---|
| addAssignee | <Assignee> |
| ( ) | <User> . . . </User> |
| | <Type> . . . </Type> |
| | <AssignedOn> . . . </AssignedOn> |
| | <StatusIID> . . . </StatusIID> |
| | <UnassigneedOn> . . . </UnassigneedOn> |
| | </Assignee> |

Attributes are elements of an entity. An example of an attribute is operation, explained above. Operation is an attribute generally required for all entities. In order for the entity to be executed, the attributes should be included.

<Project op=“insert” app=“DOCS”>

An XML document can have multiple entities, entity records and record items (elements). An XML document can include multiple entities; this means that one document can have Project, Task, Contact, etc. Each entity will have its own set of entity tags. For example:

<Project op=“insert” app=“DOCS”>

<Name>API First Draft</Name>
<NumberString>09202000-0001</NumberString>
<OpenedOn>09/20/2000</OpenedOn>
</Project>
<Task op=“insert”>
<ShortDescription>API Documentation</ShortDescription>
<PriorityIID>3</PriorityIID>
<DueOn>09/23/2000</DueOn>
<StartOn>09/12/2000</startOn>

</Task>
<Expense op=“insert”>

<ShortDescription>Materials Needed For

Project</ShortDescription>

<ExpenseDate>09/20/2000</ExpenseDate>
<ExpensedBy>carolyn</ExpensedBy>
<DefaultCategory>SUPP</Detail>
<UnitPrice></UnitPrice>
<Quantity></Quantity>
<TotalAmount>200</TotalAmount>
<Project keymap=“NumberString”>09202000-0001<Project>
<Contact keymap=“Name”>Andrews</Contact>
<Note>Additional materials needed for API

project</Note>

<PostingStatusIID>2</PostingStatusIID>

</Expense>

An XML document can also include many records of one entity. Each record will have its own set of entity tags. For example:

<Project op=“insert” app=“DOCS”>

<Name>API First Draft</Name>
<NumberString>09202000-0001</NumberString>
<OpenedOn>09/20/2000</OpenedOn>

</Project>
<Project op=“insert” app=“DOCS”>

<Name>API Second Draft</Name>
<NumberString>09302000-0001</Numberstring>
<OpenedOn>09/30/2000</OpenedOn>

</Project>
<Project op=“insert” app=“DOCS”>

<Name>API Final Draft</Name>
<NumberString>10152000-0001</NumberString>
<OpenedOn>10/15/2000</OpenedOn>

</Project>

Certain tags have multiple record items (elements); for example, Assignees in Project. As such, record items can be added more than once in an XML document. Each record item will have its own set of element tags. For example:

<Project op=“insert” app=“DOCS”>

<Name>API Final Draft</Name>
<NumberString>10152000-0001</NumberString>
<OpenedOn>10/15/2000</OpenedOn>

<Detail key=”DOCS_TECO_XMLX/>
<Detail key=”DOCS_TECO_1API/>
<Detail key=”DOCS_TECO_SCHM/>
<Assignee>

<User>jessica</User>
<Type>DOCS_TEWR</Type>
<AssignedOn>09/14/2000</AssignedOn>
<StatusIID>1</StatusIID>
<UnassigneedOn></UnassigneedOn>

</Assignee>
<Assignee>

<User>nathan</User>
<Type>DOCS_SRDV</Type>
<AssignedOn>09/14/2000</AssignedOn>
<StatusIID>1</StatusIID>
<UnassigneedOn></UnassigneedOn>

</Assignee>
</Project>

The following is an example of an XML document which contains the parts (document tag, authentication, entity, operations, elements and attributes) for sending a request to the platform. The example below distinguishes the different parts of an XML document by using different formats, fonts and colors.

| | |
|---|---|
| (1) | Bigger font size 14 and |
| Document Tag | bold |
| (a) | Font size 13 and |
| Authentication | bold/italic |
| (b) | Font size 12 and italic |
| entity | |
| (c) | Font size 12, italic and |
| attribute | font color red |
| (d) | Font size 12 |
| Simple | |
| Elements | |
| (e) | Font size 12 and font |
| Complex | color blue |
| Elements | |

<TeamConnectRequest>
<Authentication>

<Username>jessica</Username>
<Password>082535242</Password>

</Authentication>
<Project op=“insert” app=“DOCS”>

<Name>API First Draft</Name>
<NumberString>09202000-0001</NumberString>
<OpenedOn>09/20/2000</OpenedOn>
<Assignee>

<User>jessica</User>
<Type>DOCS_TEWR</Type>
<AssignedOn>09/14/2000</AssignedOn>
<StatusIID>1</StatusIID>
<UnassigneedOn></UnassigneedOn>

</Assignee>
<Assignee>

<User>nathan</User>
<Type>DOCS_SRDV</Type>
<AssignedOn>09/14/2000</AssignedOn>
<StatusIID>1</StatusIID>
<UnassigneedOn></UnassigneedOn>

</Assignee>
<Relation>

<LeftRightIID>Left</LeftRightIID>
<Project>4827</Project>
<Type>ACCT</Type>

</Relation>
<Relation>

<LeftRightIID>Right</LeftRightIID>
<Project>4905</Project>
<Type>DEFA</Type>

</Relation>
<Note>This is the second assignment corresponding to

technical writing.</Note>

<Detail key=“DOCS_TECO_XMLX”></Detail>
<Detail key=“DOCS_TECO_1API”>

<DueDate>09/25/2000</DueDate>
<MetProjectedTimeFrame>1</MetProjectedTimeFrame>
<ProjectedTimeFrame>10</ProjectedTimeFrame>
<ProjectLeader>93</ProjectLeader>
<DocType>DOTY_DEDO</DocType>
<Comments>Discussed issues pertaining to

project</Comments>

<Title>Introduction to Team Connect</Title>

</Detail>

</Project>
<Task op=“insert”>

<ShortDescription>Documentation</ShortDescription>
<PriorityIID>3</PriorityIID>
<DueOn>09/23/2000</DueOn>
<StartOn>09/12/2000</StartOn>
<CompletedOn>09/20/2000</CompletedOn>
<WorkStatusIID>2</WorkStatusIID>
<AcceptanceIID>1</AcceptanceIID>
<EstimatedHours>80</EstimatedHours>
<CompletedPercent>40</CompletedPercent>
<RateAmount>50</RateAmount>
<ActualHours>90</ActualHours>
<TotalAmount>250</TotalAmount>
<ActivityItem>TAS1</ActivityItem>
<Contact>61</Contact>
<Project keymap=“NumberString”>09202000-0001</Project>
<Milestone>1322</Milestone>
<ForwardedByAssignee>trask</ForwardedByAssignee>
<IsAccepted>Yes</IsAccepted>
<IsUnknown>Yes</IsUnknown>
<Note>API Documentation Note</Note>
<DefaultCategory>DOCU</Detail>
<PostingStatusIID>3</PostingStatusIID>

</Task>
</TeamConnectRequest>
Text-Delimited Documents

The application server 205 is compatible with text-delimited documents as well as XML documents. Many of the tags are used for both XML and Text Delimited documents; however, there are minor variations which are addressed in the XML schema. The format of these tags are generally different, as shown in the following table.

| XML Format | Text-Delimited Format |
|---|---|
| <NumberString>data</Number | \|NumberString\| |
| String> | \|data\| |

The content of text-delimited documents is generally very similar to the XML documents. Like XML, text-delimited documents contain authentication, entity, elements (simple and complex), and attributes. The text-delimited format is divided into two documents; the first stores the Authentication, Entity and Header, while the second document stores the data in a text-delimited format. As with the XML document, the user generally authenticates himself using a username and password.

Each text-delimited document pertains to one entity. The entity is preferably specified immediately after the authentication section, as with the XML document.

As with any text-delimited document, headers are included which describe the data. These headers replace the tags used in the XML documents. The headers further include field and record delimiters. A header will often include Attributes, Simple Elements, and Complex Elements:

The header also includes the necessary elements pertaining to the entity. The element will be either a simple element or complex element. Simple elements will only need to include the element name; complex elements on the other hand will include its attribute and sub-elements.

The following is an example of a Complex Element with an attribute:

Element-Attribute:Sub-element*Sub-element|

Detail-DOCS_TECO_{—}1API:DueDate*MetProjectedTimeFramel

The following is an example of a Complex Element without an attribute:

Element: Sub-element*Sub-element|

Assignee: User*Type*AssignedOn*StatusIID*UnassignedOn|

The data generally should replicate the headers, including attributes, elements or sub-elements. For example:

Header

@app|NumberString|Detail-DOCS_TECO_{—}1API:DueDate*MetProjectedTimeFrame|

Data

DOCS|09202000-0001|09/25/2000*1|

The complex element as well as its attribute is not represented in the data; the only items that should be represented in the data are generally the sub-elements.

In most text delimited documents there will also be instances where a data value does not exist. In those instances, a space should be represented in place of the empty data value. For example:

Application|NumberString|Detail-DOCS_TECO_{—}1API:DueDate*MetProjectedTimeFrame|

DOCS|09202000-0001|*|

Attributes of complex elements should only be included in the header, not the data. For example:

Header

Detail-DOCS_TECO_{—}1API:DueDate*MetProjectedTimeFrame|

Data

09/25/2000*1|

Most complex elements can have multiple record items within one field delimiter. For example:

Header

Assignee:User*Type*AssignedOn*StatusIID*UnassignedOn|

Data

nathan*DOCS_TEWR*03/25/1995*0*05/21/1995*jessica*DOCS_SRDV*05/21/1995*1* |

The above example contains two record items pertaining to the complex element Assignee. This is the format that is desirably used when creating multiple record items for a complex element. The tools used to send requests to the platform will decipher the above information as two record items.

The completed XML or Text Delimited document will be sent as a request to the platforms.

Object Definitions

The “look” of objects is generally defined from a GUI perspective. Search fields are defined for how people list their claims, policies, etc. There can be multiple views on the same object definition, and different people can view the object in different ways, depending on their respective roles. Thus, for example, a claim representative can have a first view of a claim object that is entirely different from a second view available to an adjuster who will interact with the object. This second view may be entirely different from the view of a manager who only desires to view summary information regarding the claim.

General Information

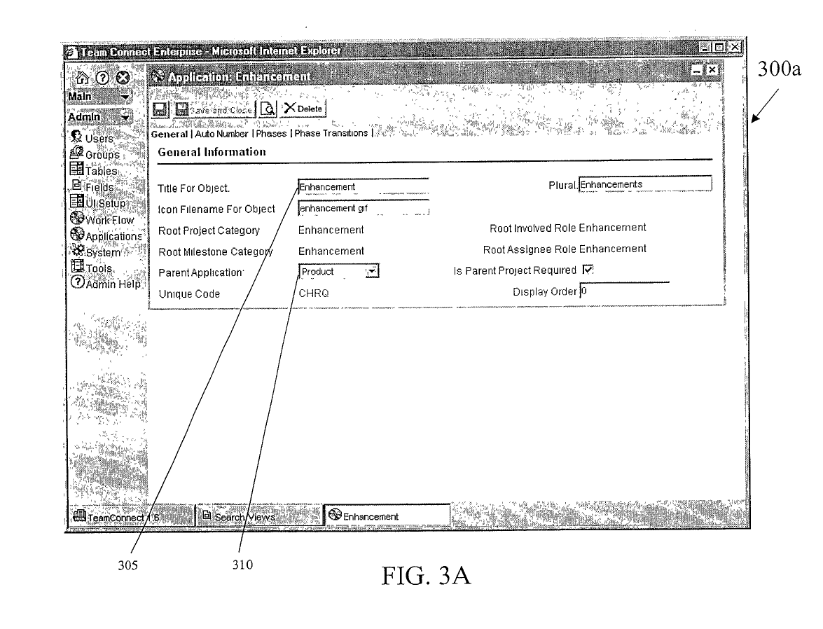

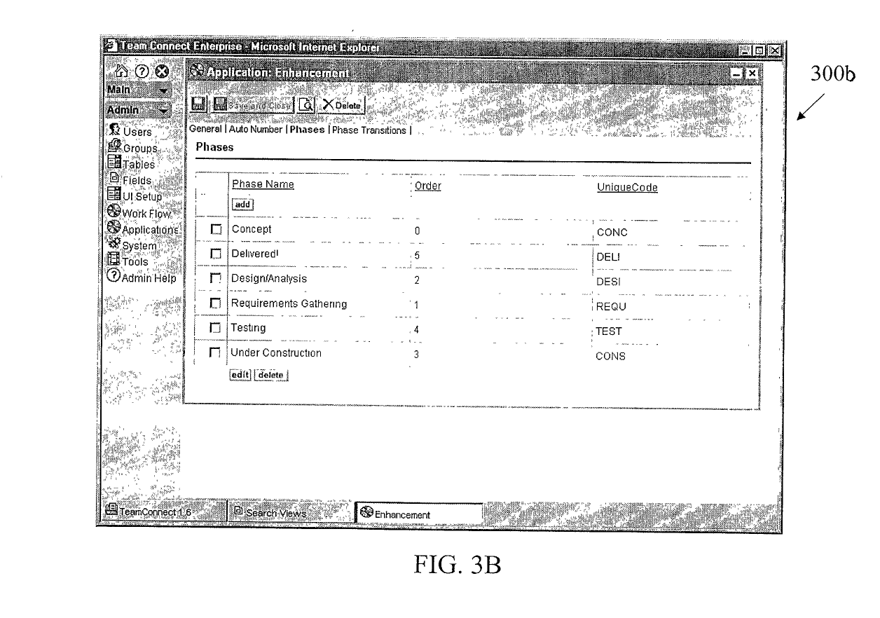

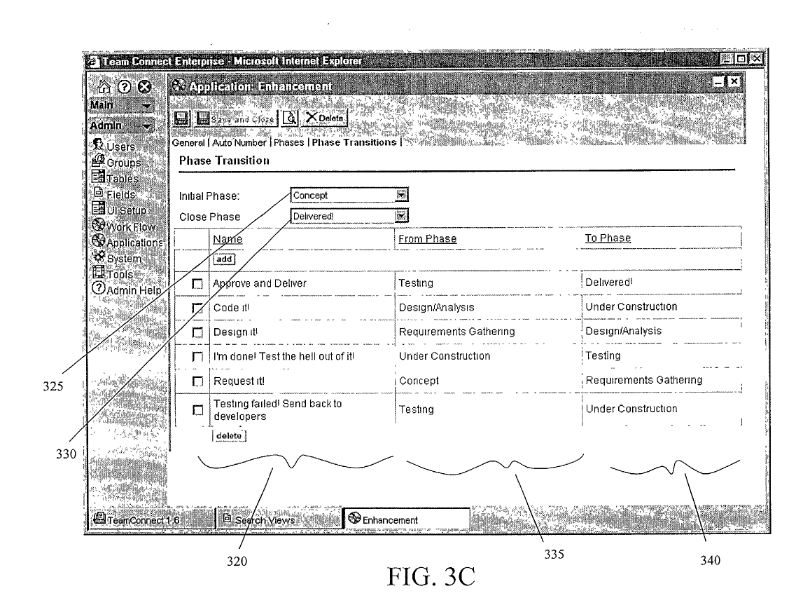

FIG. 3A shows a graphical user interface 300a for defining a knowledge object, in this example, named “Enhancement.” This title is entered in field 305, and a parent class for the “Enhancement” object is selected using pull-down menu 310.

Phases

Knowledge objects can have various phases that are provided for the particular business application. Each object goes through a plurality of phases during its life cycle, and transitions are defined. The transitions become actions that can be performed on the object (e.g., escalate, close). In one example, a new instance of an account is created. This account object starts in a prospect phase. When the person associated with the account is engaged as a customer, the account object moves from the prospect phase to a client phase. The possible phases and meaningful transitions between them are defined by an administrator during the design phase, and rules can be tied to the transitions. These rules will be instigated so operations will be done automatically when an object moves from phase to phase. Each transition will often generate new workflow for people assigned to the object, and/or assign new people as the object as it goes from one phase to another.

The current phase of an object is an attribute of the object. Each object also has a history of the phases through which the object has gone through. In this way, the user can see when the object started, when it transitioned, etc.

In another example, a class called support issue is defined. When a customer support representative receives a call from a client requesting assistance, the representative generates a new support object that has an initial phase. The object can move to an escalation phase where more attention can be given to it and new tasks created for it. Then the object can move to a results phase where the issue is closed. In an alternative embodiment, the object moves from the initial phase to a development phase.

FIG. 3B shows a graphical user interface 300b for defining phases associated with a knowledge object or application named “Enhancement.” In this example, the phases include “Concept,” “Delivered,” “Design/Analysis,” “Requirements Gathering,” “Testing,” and “Under Construction.” These are phases through which a typical Enhancement passes. An order for the phases can also be specified, as shown in FIG. 300b.

FIG. 3C shows a graphical user interface 300c for defining phase transitions for the “Enhancement” knowledge object. The names of actions representing the various transitions for the object are shown in a first column 320. The appropriate transition is executed when a particular action name is called. An initial phase for the object is specified in pull-down menu 325, and a close phase is specified in pull-down menu 330. For each action in column 320, an appropriate “From Phase” is specified in column 335 and “To Phase” specified in column 340. For example, for the “Request It?” action, the object transitions from phase “Concept” to phase “Requirements Gathering.” From this phase, the object moves to “Design/Analysis.” From this phase, the object moves to “Under Construction,” and so on. From any given phase, there can be a plurality of “To Phase” options. For example, from “Testing,” the object can move to “Delivered!,” or “Under Construction,” depending on the testing results. Using GUI 300C, the life cycle of the “Enhancement” object is defined.

Assignees

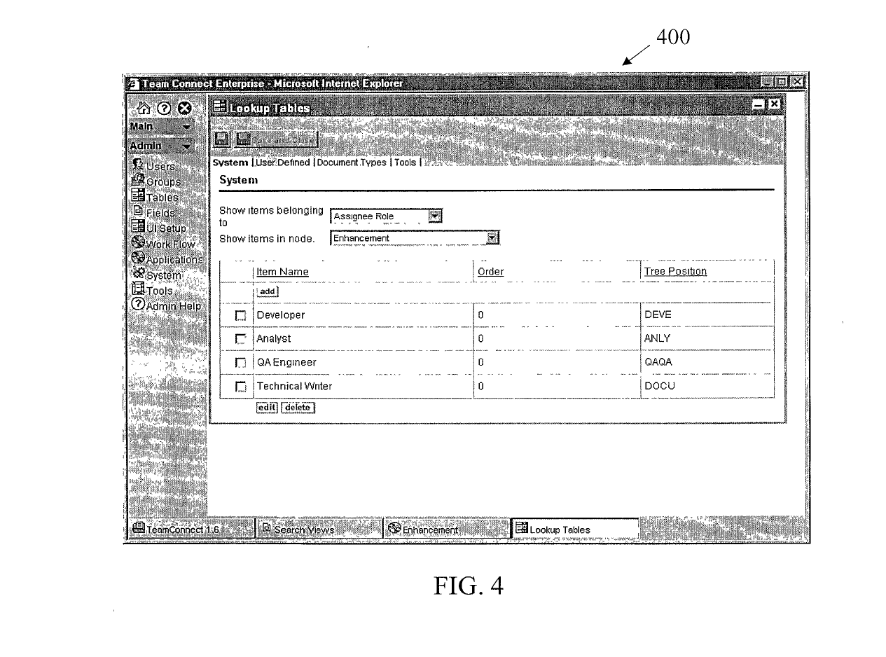

FIG. 4 shows a graphical user interface 400 for associating one or more assignees with a knowledge object. The assignees may have different roles. In one example, for the object “Enhancement,” one role is “Developer,” another is “Analyst,” and another is “QA Engineer.” Other roles can be defined depending on the desired implementation.

Attributes

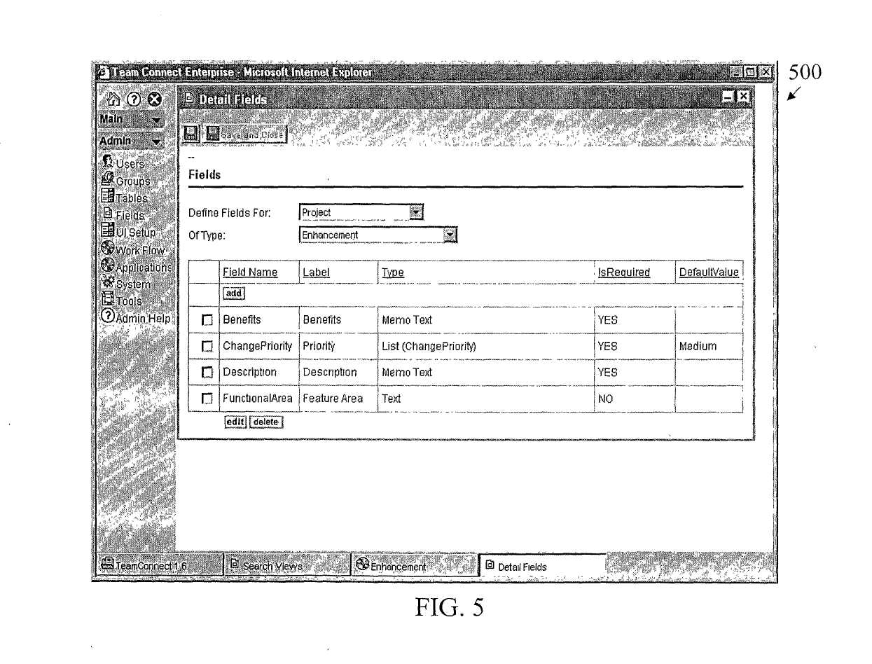

FIG. 5 shows a graphical user interface 500 for tracking attributes associated with the knowledge object “Enhancement.” One attribute named “Description” is a Memo Text providing a description of the object. Another attribute named “Priority” is a List with a plurality of predefined selections (e.g., high, medium, low). Other attributes are shown in FIG. 5. Each attribute or field can be required or not, as specified in an “IsRequired” column. Also, a default value can be specified in column “DefaultValue,” such as “Medium” for field “Priority.”

Rules

Rules are associated with the transitions and can be triggered automatically. For example, rules may be triggered as the object transitions from phase to phase, or rules may trigger on updating an object (e.g., check that certain fields meet certain parameters, send an e-mail to a predetermined address, generate a new task, etc.).

Rules are generally created using an object-oriented programming language such as Java. Creating rules is generally a two-step process: First, the various rules are written; second, handlers are created to run the various rules. Each object rule class will generally include items to import, class definitions, and methods. The following is a model for an object rule class:

public class ClassName extend TCDefaultRuleHandler
{

ClassType variableName;
public ClassName (ClassType variableName)
{
try

{
this.variableName = variableName;
}
catch (java.lang.NullPointerException npe)
{
TCDebug.logRuleMessage(“ClassName: Null pointer

encountered !!!!!”);

}
}
public void runRule()
{

/*user's code here*/

}

}

For Example:

public class Contact extends TCDefaultRuleHandler
{
TNContact cntObject;

public Contact(TNContact cntObject)
{

try
{

this.cntObject = cntObject;

```
  }
catch (java.lang.NullPointerException npe)
  {
```

TCDebug.logRuleMessage(“Contact: Null pointer

encountered !!!!!”);

}

}

private void runRule()
{

TCDebug.logRuleMessage(“Entering Data

Validation For Social Security”);
String strSSN = cntObject.getSocialSecurity();

if (strSSN == null)
return;

TCDebug.logRuleMessage(“String SSN is

” + strSSN);

if (strSSN.trim().length() != 11)

throw new TCException (“Social

Security Number can only be 9 digits”);

try

{

Double dblSSN = new Double(strSSN);

}

catch(java.lang.Exception e)

{

throw new TCException(“SSN must be

numeric only”);

}
TCDebug.logRuleMessage(“Leaving Data Validation For

Social Security”);

}

}

The rule classes extend TCDefaultRuleHandler or implement TCRuleHandler. These classes contain the logic behind the rules. The Main Object for which the rule class will pertain to is then defined by setting the Class Type and Variable Name. The Class Type can be any of the Main Objects (TNAppointment, TNContact, TNProject, etc.). The “public void runRule( )” method is called by the rule engine. This method contains the backbone of the rule logic.

Some rules pertain to system or user-defined lookup tables items or detail fields. The user passes an argument when using methods of these types; the argument will vary depending on whether the method is a lookup table item or detail field. The argument needed for methods pertaining to a lookup table item is the tree position of the method. The tree position can be found in the platform UI (User Interface). Since most tables can have a hierarchy order, the user can get the tree position of every item in the hierarchy and separate them with an underscore “_.” The example below lists items in the project category and their tree positions. To get values pertaining to Auto, the tree position for both Auto and its parent Insurance are used:

Insurance (INSU)

Auto (AUTO)

project.getDetailForKey(“INSU_{—AUTO”)}

In many instances, the user will desirably create a rule pertaining to detail fields, generally using two items: detail field type (text, number, memo, list, date, check box or involved), and the detail fields field id. The methods vary according to the field type. For example, the following methods get the data pertaining to the detail field.

| Field Type | Method |
|---|---|
| Check Box | GetDetailBoolValueForKey(FieldID) |
| Date | GetDetailDateValueForKey(FieldID) |
| Involved Role | GetDetailInvlValueForKey(FieldID) |
| Memo | GetDetailMemoValueForKey(FieldID) |
| Number | GetDetailNumbValueForKey(FieldID) |
| List | GetDetailObjeValueForKey(FieldID) |
| Text | GetDetailTextValueForKey(FieldID) |

Methods pertaining to detail fields will use the field ID as arguments. Like the tree position for lookup table items, the field ID and field type are generally available.

Once the various rules are written for the application, the handlers can be created. The handler provides control over what rules run during a particular instance. The Rule Handler has many functions, including: (1) inserting the name in the rule pull-down list for the user to select a rule, (2) the option to run a rule during save or when a user selects the rule from the pull-down list, (3) the option to have each rule have its own handler or one handler contain multiple rules for an object, and (4) the option to run rules in a specific order. Each handler generally includes the following: (1) items to import, (2) defining the class, and (3) methods.

Generally, each handler class will extend from the TCEntityRuleHandler class. This class is loaded during runtime. Since the class is extended from TCEntityRuleHandler, when the platform is loaded, the Rules Classes folder (explained below) will be automatically accessed. Classes that have been extended from TCEntityRuleHandler are identified and inserted into a table in memory. So anytime a record is saved, the platform will check the table to see if a rule has been defined. The Handler Class defines the type of Object (Contact, Task, etc) for which the rule will be run. The following method returns an object of the class “TCRuleHandler:”

public TCRuleHandler handlerObject(Object object)
{

TCDebug.logRuleMessage(“Enter unique string here for

debugging purposes”);

ClassType variableName = (ClassType) object;
return new RuleClassName(variableName);
new RuleClassName(variableName).runRule();

public boolean shouldRuleRunOnSave()
{
return false;
}

}

Approval Rules can be created and associated with various actions. For example, when an individual posts an expense greater than a predetermined amount, that action may desirably pass through an approval chain. In this case, approval rules will be created as part of a custom object. Another example deals with the changing of phases. After an insurance claim representative has entered relevant information into a claim object, the object will pass into another phase, e.g., “Investigation” or “Inspection.” The claim is accordingly assigned to an investigator or inspector. Other custom business rules can be triggered that automatically select, for example, an adjuster to assign to the claim. This selection will be based on certain criteria including location of where the claim arose, availability of claims adjusters, etc.

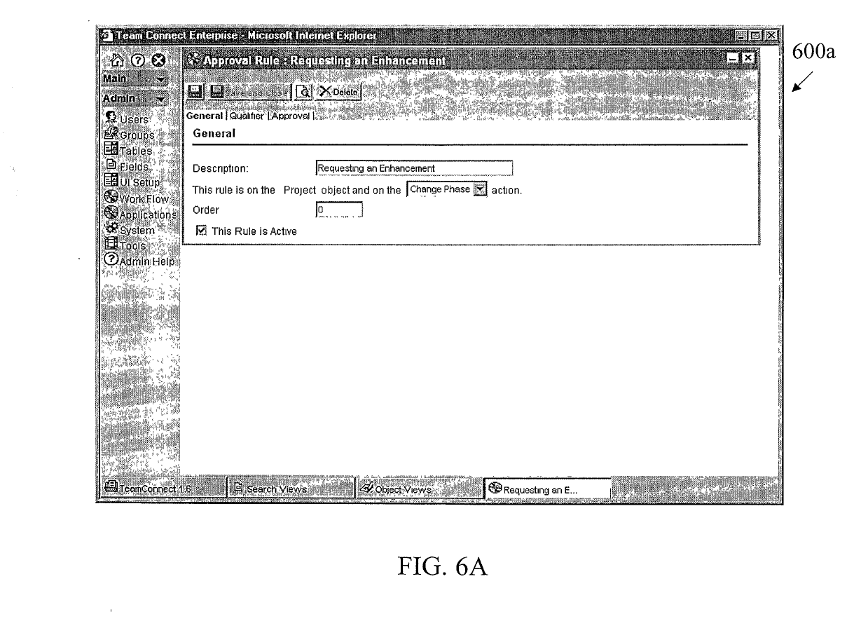

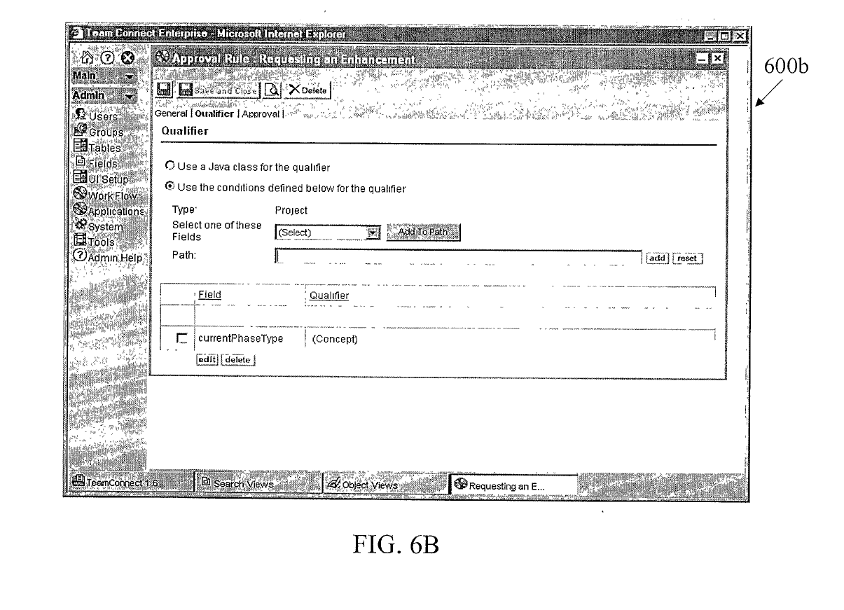

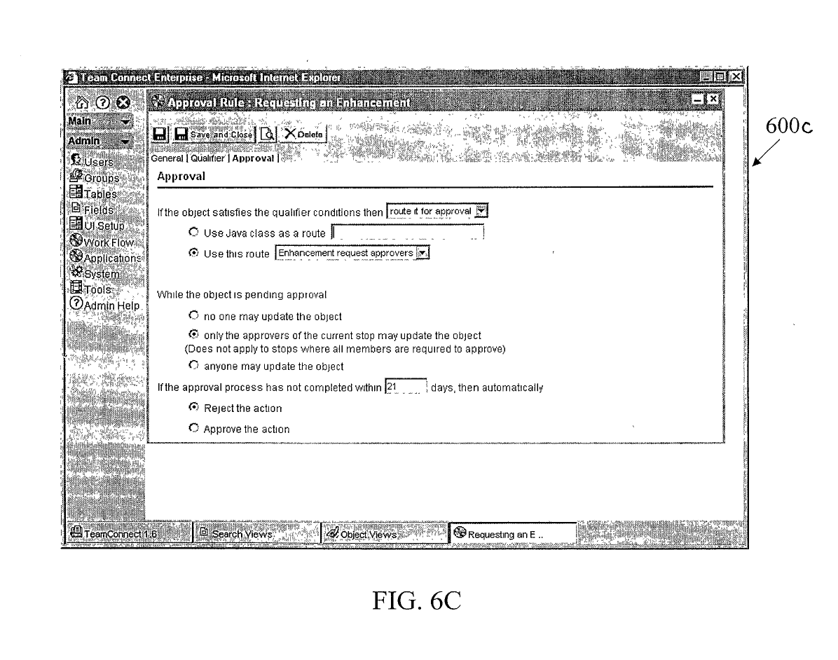

FIG. 6A shows a graphical user interface 600a allowing a user to specify an object and an action with which the rule is associated. In the example of FIG. 6A, the rule is on the “Project” object and on the “Change Phase” action.

Qualifiers

In FIG. 6B, a graphical user interface 600b allows the user to set a qualifier for the rule. In the “Enhancement” example, a set of qualifiers are defined such that a rule is triggered when the knowledge object satisfies the qualifiers. In particular, when the current phase is “Concept,” the rule is triggered. More complex qualifiers can be used, as will be understood by those skilled in the art.

When qualifiers are met, the associated rule is triggered and routed for approval. In FIG. 6C, a graphical user interface 600c is provided for defining a route. The route definition generally includes a plurality of stops, and at each stop there are one or more members whose approval is requested or required.

Operation

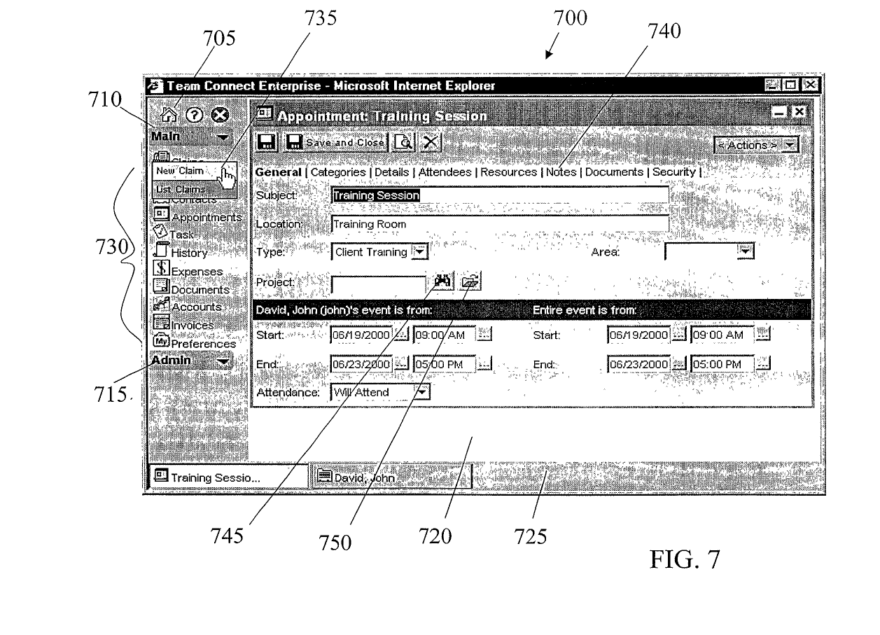

FIG. 7 shows a graphical user interface 700 generated according to an exemplary embodiment of the present invention. A left region 705 of the interface has two menu bars, a Main Menu Bar 710 and an Admin Menu Bar 715. Each menu bar directs the user to various objects within the platform. A workspace region 720 is the main area where most of the work is done. Within this area users and administrators will search, enter, view, delete, and/or change data. A bottom region 725 displays Icons for Files/Objects currently opened. The user can move to any of the open files by clicking the desired file icon.

In FIG. 7, the left region 705 of the interface 700 includes a plurality of menu buttons 730 displayed under the main menu bar 710. These include Project, Contact, Appointment, Task, History, Expense, Documents, Accounts, Invoices and Preferences. Each menu button takes the user to a Popup Menu for a specific object. When the user clicks the administrative menu bar, icons representing the following objects are displayed: Users, Groups, Tables, Fields, Forms, Settings, Applications and Custom Views. For most objects, whenever the user clicks on a Menu Button, a Popup Menu will display. The Popup Menu will display two or more of the following options:

New Object

(e.g., New Company or New Person)

List Object

(e.g., List Contacts)

For example, in FIG. 7, when the user clicks on the “claims” menu button, a popup menu 735 appears with two fields: “new claims,” and “list claims.” Within the various objects, there is a general page and often a plurality of other pages. A plurality of tabs 740 with descriptive headings are displayed above the workspace region 720 and allow the user to select the appropriate page: “General,” “Categories,” “Details,” “Attendees,” “Resources,” “Notes,” “Documents,” or “Security.”

A Find/Add Module will be displayed when a contact or project selection is required. There are two types of Find/Add Modules: a Project Module and a Contact Module. The Project Module will search and find existing Projects to associate to an object. The Contact Module will search and find existing Contacts as well as create new Contacts to associate to an object. There are some differences between the Contact and Project Modules that are addressed below, but there are many similarities. A first button 745 opens the Project Module and Contact Module, where the user can Search for a Contact or Project and select it for the Object. A second button 750 links to the selected Contact or Project.

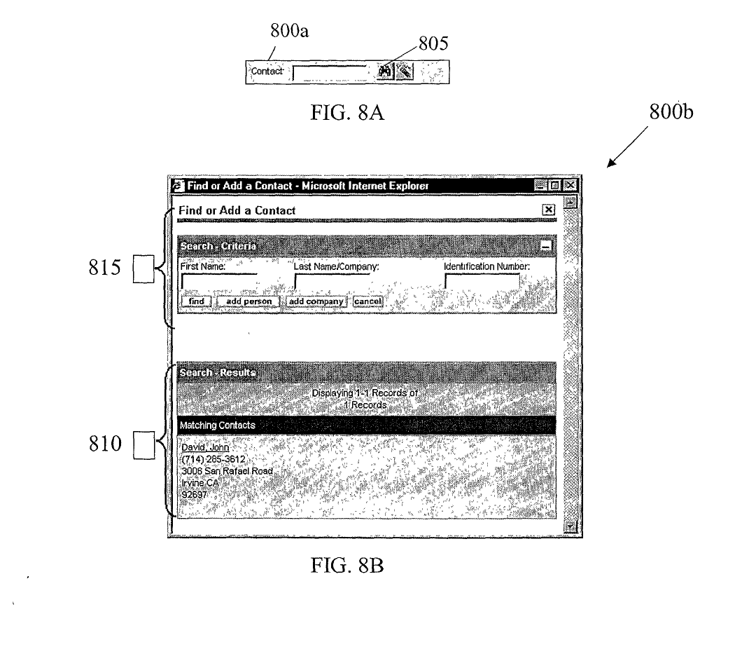

When a Contact is required, the Contact Module will be made available. This module allows the user to find and select an existing contact as well as create a new contact to associate to an object. A Field 800a for Contact information will appear, as shown in FIG. 8A. The user can click on a Find Button 805 to associate a Contact with an object. A Contact Module dialog box 800b will then be displayed, as shown in FIG. 8B.

In FIG. 8B, the Contact Module dialog box 800b is divided into two sections: Search Criteria 810, and Search Results 815. The Search Criteria 810 allows the user to search for an existing Contact. The user can enter the criteria in “First Name,” “Last Name/Company” and/or “Identification Number” fields. This area also allows the user to create a new Contact. By entering the First Name, Last Name/Company and/or Identification Number and clicking New Person or New Company, the Contact Module will add the new Contact and associate it to the object. The Search Results 815 displays the results of the user's search criteria. From this area the user can select the Contact he would like to associate to the object by clicking on the Contact's Hyperlink. The Results displays the Contact's First Name, Last Name, Default Phone Number and Default Address.

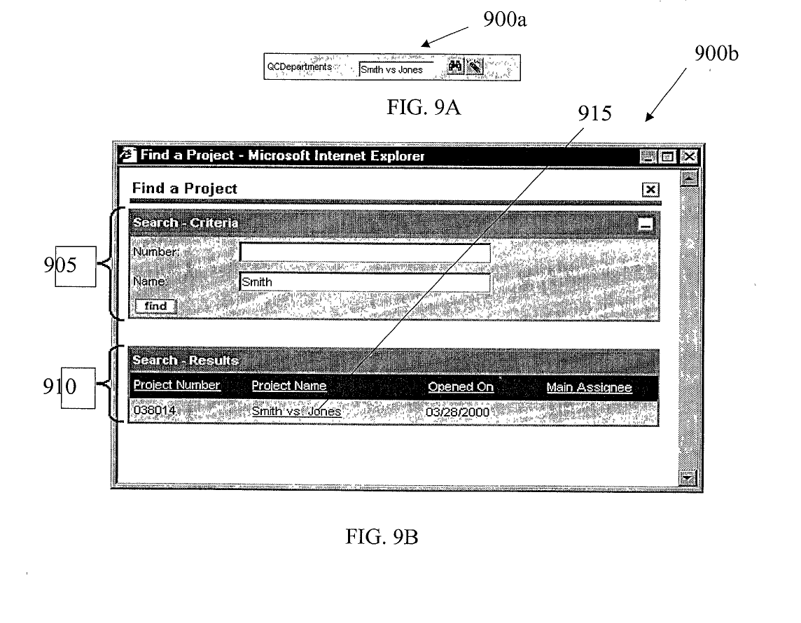

When a Project is required, a Project Module will be made available. This module allows the user to select an existing project to associate to an object. A Project field 900a, as shown in FIG. 9A, is labeled “Projects” until the user associates a Project and clicks “Save.” The label is then renamed to the Specific Project, in this case “QCDepartments.” As shown in the populated project field 900a, “Smith vs. Jones” is from QCDepartment. The Project Module 900b is divided into two sections: Search Criteria 905 and Search Results 910. The Search Criteria 905 section allows the user to search for an existing Project by entering the criteria in the Number and Name fields. The Search Results field 910 displays the results of the search, using the search criteria. From this area, the user can select the Project to associate with the object by clicking on the Project's Hyperlink 915. The Results displays the Project's Number, Name, Opened Date and Main Assignee.

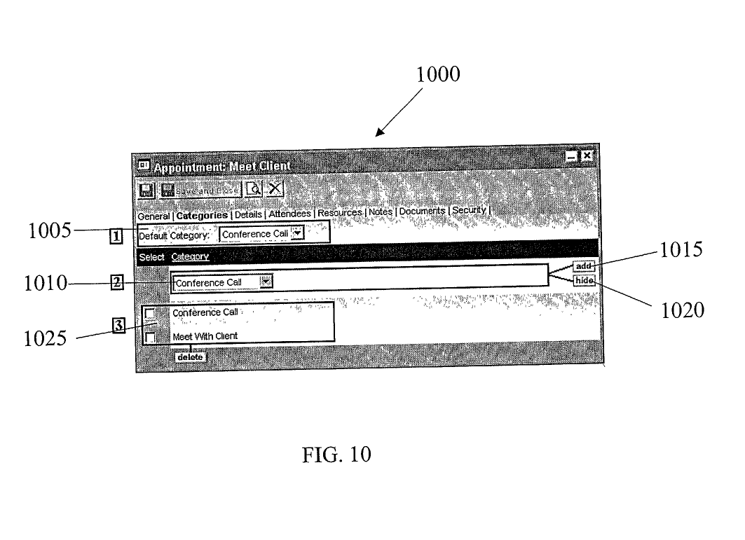

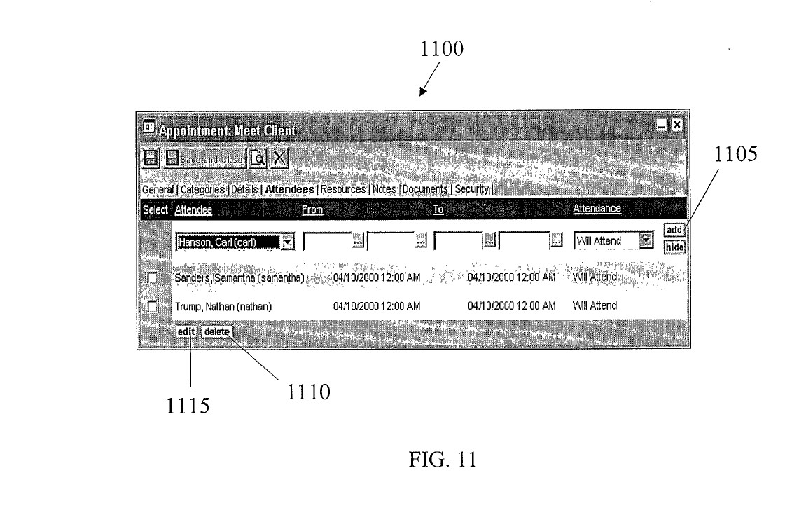

Various Object Tabs (e.g., Appointment Categories Tab) allow the user to add more than one record item. All of the available record items can be selected from a pull-down list displayed on a screen 1000, as shown in FIG. 10. The user has the option of adding, deleting and editing one or more record items. The screen 1000 can be divided into two or three areas, depending on the Tab. Certain tabs can have a default item 1005, for example, the User who is the Main Assignee for a Project, or the Default Category for a Contact. Object Tabs that have a Default include the All Object Category's Tab, and the Project Assignees Tab. If given the right, the user will be able to add items. The items will vary from a pull-down list 1010 to a number of fields (e.g. Date, Time, Number, etc.). The Add button 1015 and Hide button 1020 will enable or disable the data entry area. The added items will be displayed in a third section 1025. If given the right, the user can view the added items as well as being able to edit, delete, reassign (Project Assignees) and unassign (Project Assignees) one or more of these items. The Delete, Edit, Reassign and Unassign buttons pertain to this section.

FIG. 11 shows a graphical user interface 1100 providing multiple fields for an Appointment item. An Appointment Attendees tab contains a User pull-down list, Date Fields, and a regular pull-down list. To add an item, the user clicks an Add button 1105 if the data entry area is not displayed. The user selects or enters the information related to the Item in the corresponding fields, clicks add button 1105, and then clicks “Save” or “Save and Close.” To delete an item, the user selects a check box corresponding to the item he would like to delete, clicks a delete button 1110, and then clicks “Save” or “Save and Close” to save the new information. To edit an item, the user selects a check box corresponding to the item he would like to edit. He then clicks an edit button 1115, and he makes the necessary modifications.

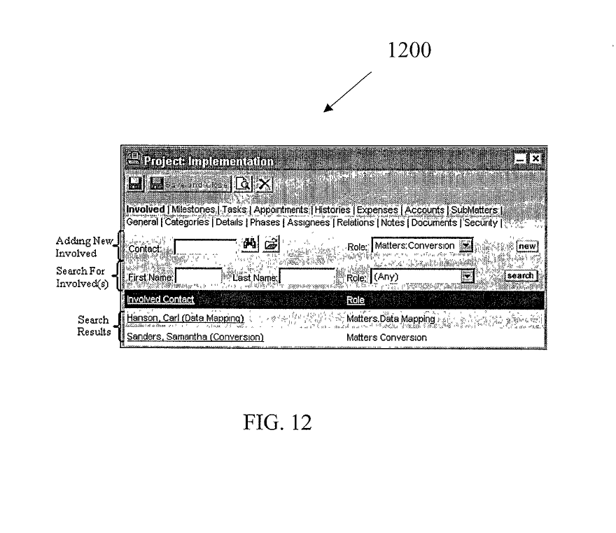

FIG. 12 shows a graphical user interface 1200 for adding a plurality of Contacts. A user can select an Item from a pull-down list or Contact Module.

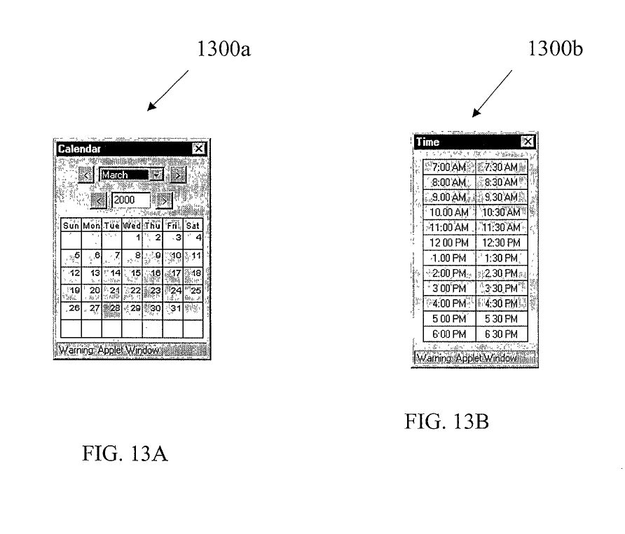

FIG. 13A shows a graphical user interface 1300a providing a Popup Calendar. There are many fields in which a Date and/or Time field is available. The user has the option of either entering the date by keyboard or selecting a corresponding button to activate the Popup Calendar or the Time Selector. FIG. 13B shows a graphical user interface 1300b providing a Time Selector. The user has the option of either using the keyboard for entering the Time in the Field or Selecting the Time from the Time Selector. The Time Selector allows the user to quickly select the time using a mouse. Like the Popup Calendar, the Time Selector will close and enter the selected time as soon as the user selects the Time.

2. Create A New Project Record

In FIG. 7, to create a new project, the user clicks a Project Menu icon and selects a “New Policy” entry from a displayed Popup Menu. The user is then linked to a Project General Tab. If (Auto) is not displayed, the user can enter a Number and Name. In certain cases, a Detail Form will be displayed. This is the Detail Form for the Root Application Category; information can be entered in the Detail Form. Project records can also be modified and deleted.

3. Project General Tab

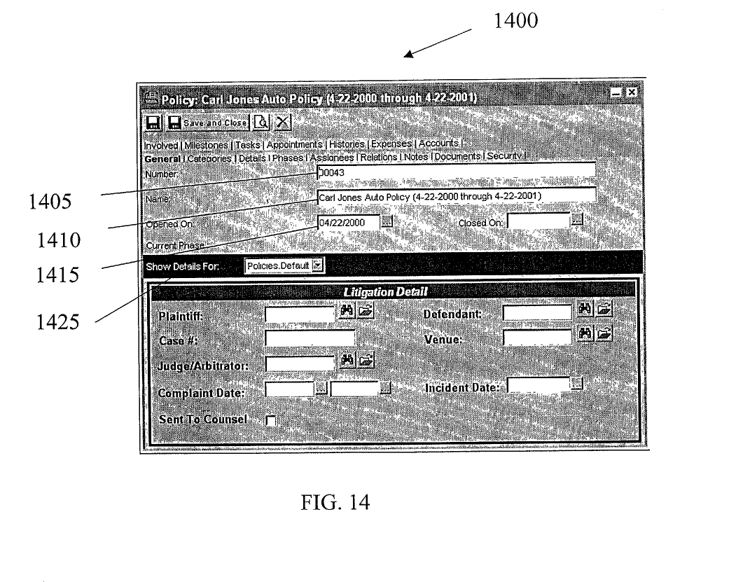

A General Tab 1400 contains general information pertaining to the Project Record, as shown in FIG. 14. The following table sets forth the fields within the General Tab.

| Field | Description |
|---|---|
| Project | The Project Number can either be manually |
| Number | entered, or automatically generated once |
| 1405 | the Administrator has set the pattern. If |
| | the number is going to be automatically |
| | generated, the field will have an (Auto) |
| | displayed; if not, the field will be |
| | blank. Once the Project Record is saved, |
| | the (Auto) will change to the Project |
| | Number that has been assigned by the |
| | Administrator. |
| Project Name | The Project Name is the Name of the |
| 1410 | Project Record. |
| Open Date | By default, the Date the Project Record |
| 1415 | was created will be the Date displayed in |
| | the Open Date. A different date can be |
| | entered using, for example, the popup |
| | calendar. |
| Phase Status | Throughout the life of a Project, it will |
| | go through a number of different phases; |
| | the Phase Status is the Phase in which the |
| | Project Record is currently in. |
| Show Details | This pull-down list is linked to the |
| For 1425 | Categories tab and the Default Category of |
| | the Project Record. It displays all added |
| | categories pertaining to the Project |
| | Record. This pull-down list pertains to |
| | the Detail Form pertaining to the Default |
| | Category. If the Default Category has a |
| | Detail Form it will be displayed below |
| | this pull-down list, if not nothing will |
| | be displayed. |
| | A New Project Record, by default, will |
| | display the Root Category and its |
| | associated Detail Form. |

A project record will often go through a number of different phases in its life. The Phase Status is the phase in which the project record is currently situated. Each phase can represent a part of the cycle for which it is currently situated. The Phase History for each Project Application will likely be different. When creating a new Project Record, the Initial Phase will automatically be set and displayed in the Project General Tab under Current Phase. The phase history can be changed using a “Change Phase To” pull-down list.

4. Project Assignee Tab (Assigning A User To A Project)

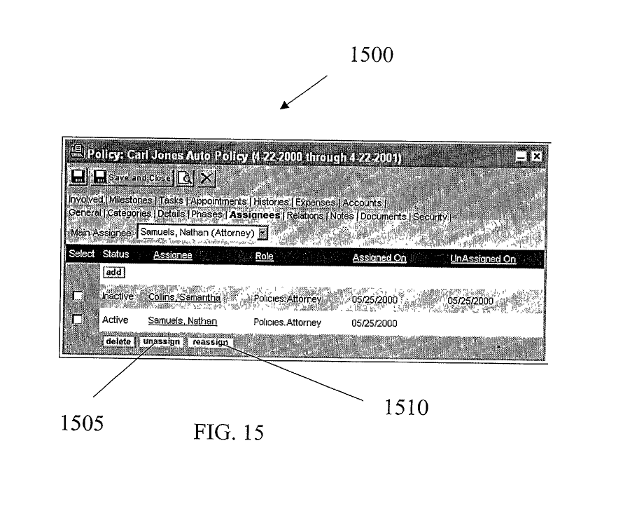

FIG. 15 shows a graphical user interface 1500 which presents a project assignee tab. Using interface 1500, one or more users can be assigned to a project. Each assignee can have a different role in relation to a project. The particular assignees and roles can be selected from pull-down lists as shown in FIG. 15. Once the assignees have been added to the project, the roles the respective assignees have in handling the project should be assigned. An “unassign” button 1505 unassigns the selected User(s) from the Project. Once the User has been unassigned, the Status column will display Inactive. A “reassign” button 1510 reassigns the selected User(s) to the Project. Once the User is reassigned, the Status Column will display the User as Active.

Once a user is assigned to the project record, he may receive an e-mail automatically generated by the platform informing him of the assignment. The email is generally sent to a Default E-mail Address listed on the Contact General Screen.

5. Project Relations Tab

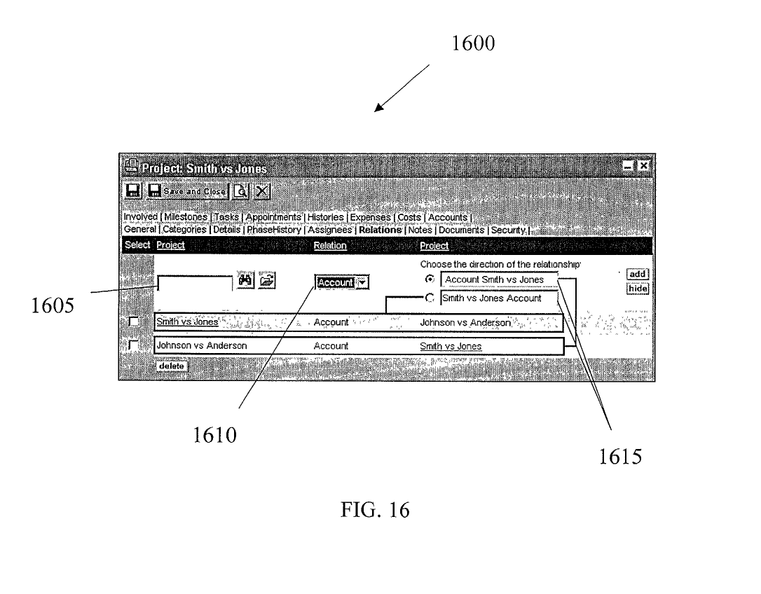

As shown in FIG. 16, a Relations tab 1600 allows one to associate other projects within one application or from any other application. The following table summarizes the fields set forth in FIG. 16.

| Field | Description |
|---|---|
| Project Module | The Project Module locates a Project |
| 1605 | from any application that the user has |
| | access to. |
| Relation | The Relation pull-down list allows the |
| 1610 | user to select the type of relationship |
| | that the Projects have with one |
| | another. |
| Project | The direction of the relationship |
| 1615 | explains how the Projects are related. |
| (Direction of | For example, FIG. 16 shows the |
| Relationship) | Relationship between Smith vs. Jones |
| | and Johnson vs. Anderson. The |
| | direction of the relationship is |
| | whether: |
| | Smith vs. Jones is the Account of |
| | Johnson vs. Anderson |
| | -OR- |
| | Johnson vs. Anderson is the Account of |
| | Smith vs. Jones |

6. Involved Object

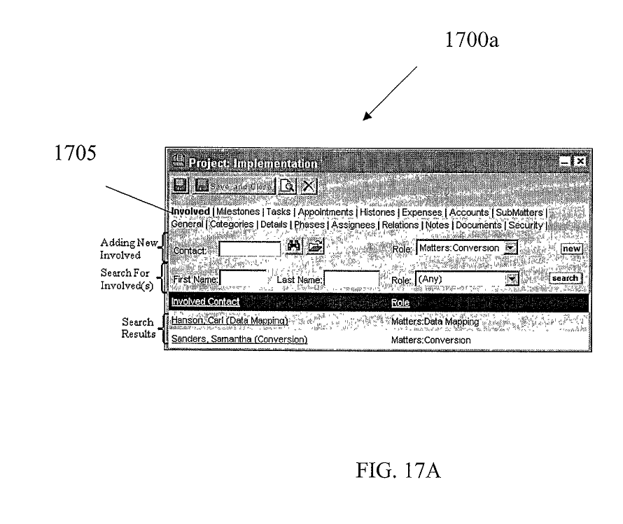

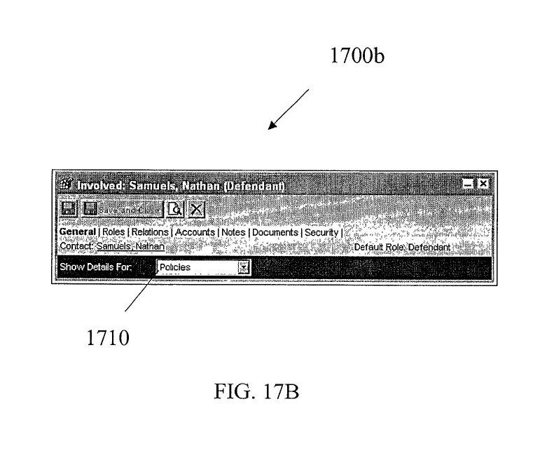

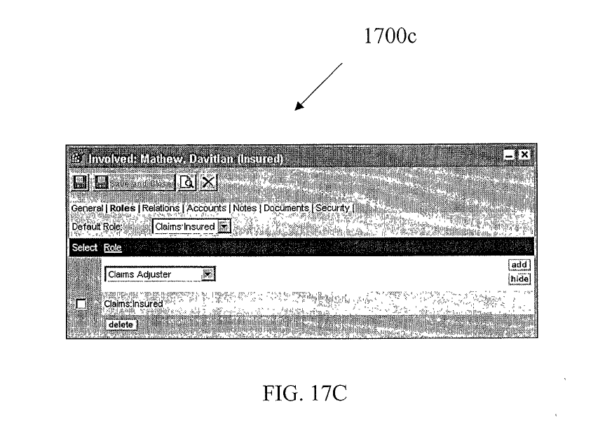

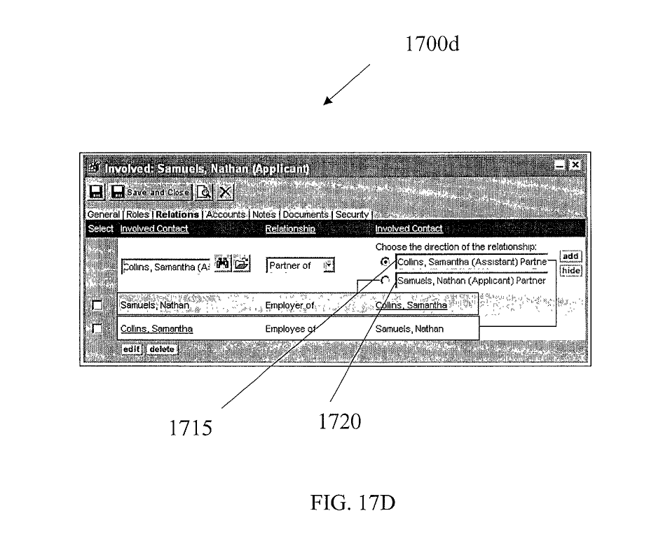

As shown in FIG. 17A, an Involved is a contact that plays a role in a project. Associated with each involved are a series of tabs provided to store additional information regarding the involved contact. When the user clicks an Involved Tab 1705, a list is displayed including all of the contacts as well as the roles they play in the project.

If there are many contacts involved in a project, and there are a number of records listed under the involved tab, the user may search and find a specific involved record by using a search option. This option allows the user to search by any one of the following: Contact's First Name, Contact's Last Name, and Contact's Role in which they are involved. Alternatively, the user may use a scroll bar to access the involved contact. The user can also select an Involved Contact Hyperlink that will link the user to the Involved Tabs where the user can enter specific details concerning the Involved Contact. To add an involved, the user may search and access an existing contact card or add a new contact.

In FIG. 17B, an Involved General Tab 1700b displays a selected Involved and his/her default role. The Involved Contact Hyperlink links to the Contact General Tab for that Involved. The hyperlink will display if the user has been given the Functional and Object Level Rights to view the Contact Record; otherwise, it will display “SECURED.” The Tab also will display the Detail Form pertaining to the Roles that have been added in the Roles Tab. Like Project Records, Involved Records display a Detail Form in the General Tab so the user can quickly and easily view the information. A “Show Details For” pertains to the Detail Form. This pull-down list 1710 is linked to the Involved Roles tab and displays all added roles pertaining to the Involved Record. If the Default Role has a Detail Form it will be displayed below this pull-down list; if not, nothing will be displayed. A New Involved Record, by default, will display the Default Role and its associated Detail Form.

As shown in FIG. 17C, an Involved Roles Tab 1700c contains the possible role types an involved can have in relation to a project.

As shown in FIG. 17D, an Involved Relations Tab 1700D allows a user to associate and create relationships between the involved contacts within a project. A top radio button 1715 represents the Involved Contact who is on one side, and a bottom radio button 1720 represents an Involved Contact who is on the other side. The user can establish as many relationships as he would like pertaining to the Involved Contact he is working on. The user can establish one-way relationships and two-way relationships.

Milestones

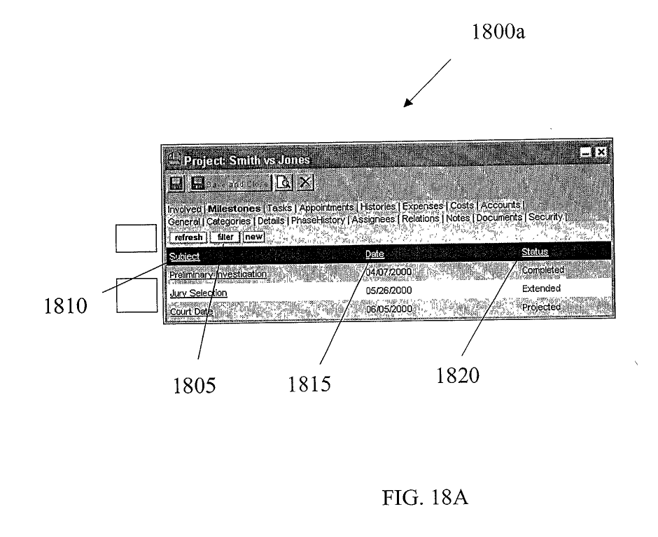

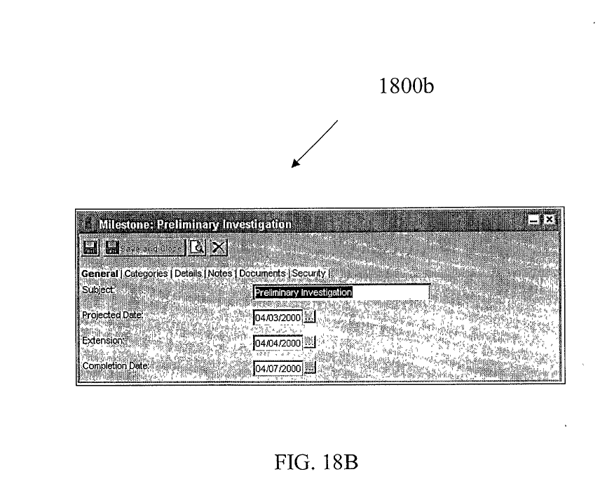

Milestones are activities pertaining to a specific project. Multiple milestones can be associated to a project record. Each milestone can have a number of appointments and tasks associated with it; examples of milestones include Pretrial Preparation, claims Investigations, and Site Survey. The Milestone Tab in Project displays the information shown in FIG. 18A. A user can search for a milestone by clicking a Filter button 1805, then searching according to the following criteria: Subject, and Projected Date. Once the Milestones are retrieved, the user can select the Milestone Hyperlink to view, modify or delete. This will link to the Milestone Tabs where the user can enter specific details concerning the Milestone. Another area displays the list of milestone records that have been added to the project record. The user can click on the hyperlink to display the General Tab of each milestone.

| Subject | |
|---|---|
| 1810 | Name of Milestone |
| Date | Date the milestone is due or completed |
| 1815 | (this Date corresponds to the Status |
| | Field). |
| | Projected Date |
| | Extended Date |
| | Completed Date |
| Status | Status corresponds to the above Date |
| 1820 | Field; this depends on which of the three |
| | dates mentioned above have been entered |
| | (one or all). |
| | Projected Date |
| | The Projected Date will appear if there |
| | is a Projected Date entered in the |
| | Projected Date Field in the Milestone |
| | General Tab. |
| | Extended Date |
| | The Extended Date will appear if there |
| | is an Extended Date entered in the |
| | Extended Date Field, even if the |
| | Projected Date has been entered in the |
| | Milestone General Tab. |
| | Completed Date |
| | The Completed Date will appear if there |
| | is a Completed Date entered in the |
| | Completed Date Field, even if the |
| | Projected Date and the Extended Date |
| | have been entered. |

Using the interface 1800a, milestones can be freely added and deleted as desired by the user.

FIG. 18B shows a graphical user interface 1800b presented to the user when a Milestones General tab is selected.

Contacts

Contacts are generally individuals and organizations that interact with the organization within which the platform is maintained. An exemplary contact contains the information shown in the following table.

| Person's Name & | Company's Name & |
|---|---|
| Identification | Identification |
| Prefix | Company Name |
| First Name | Tax ID |
| Middle Name | Evaluation |
| Last Name | |
| Suffix | |
| Salutation | |
| Job Title | |
| Driver's License | |
| Social Security | |
| Evaluation | |
| Birth Date | |

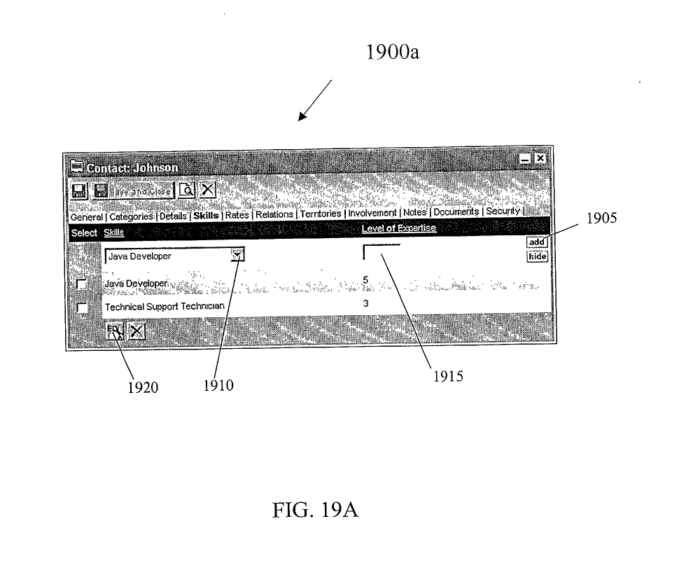

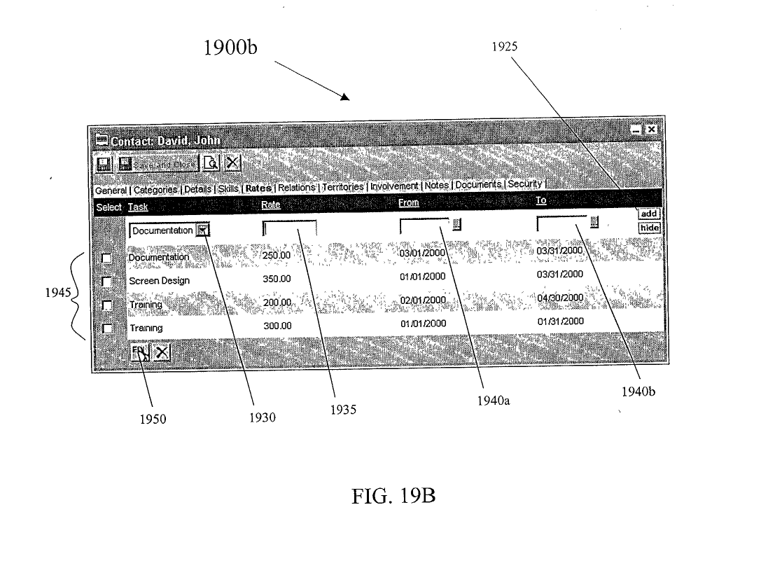

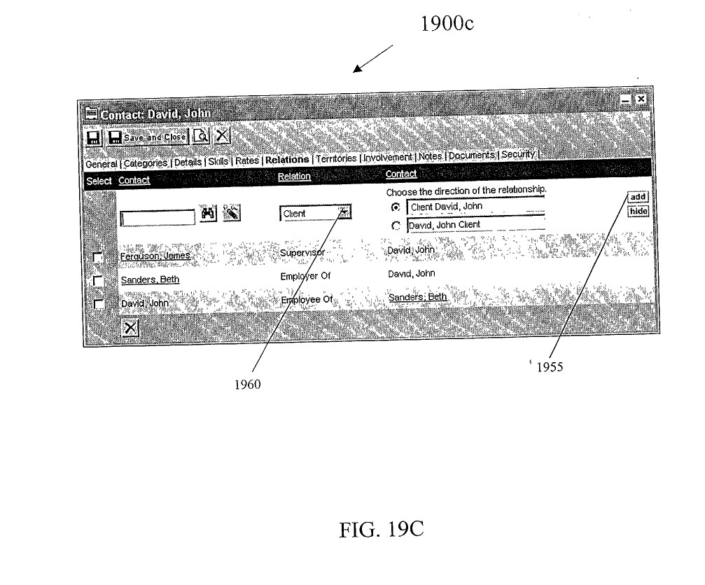

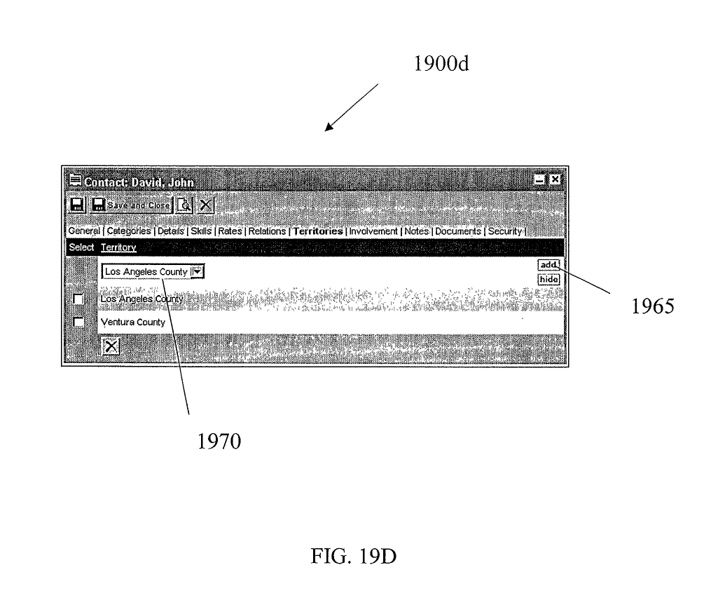

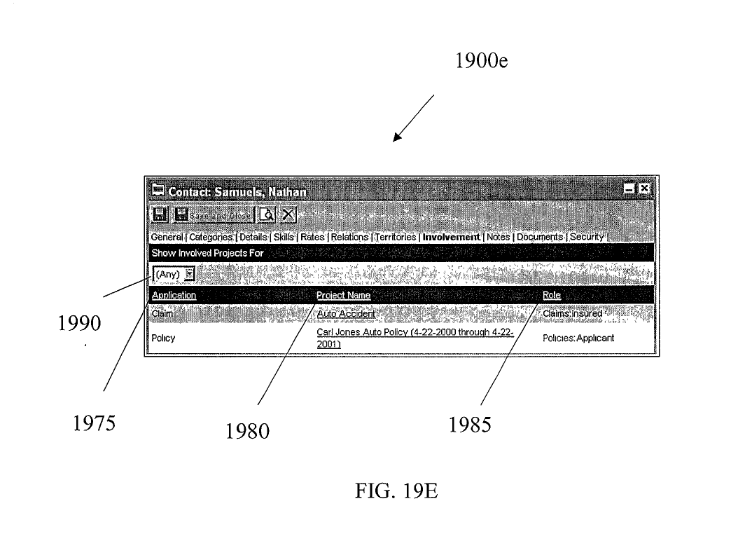

A Contact General Tab contains part or all of the information set forth in the table above, and also addresses, phone numbers, e-mail addresses, and other addresses. In addition, a plurality of skills can be 10 associated for a Contact and a level of expertise defined for each skill, as shown in the graphical user interface of FIG. 19A. The user can add a contact by clicking “add” button 1905. A new Skill can be selected from Skills pull-down list 1910, and a numeric level of expertise added in field 1915. The Skills can later be edited using an edit button 1920.

One or more Tasks and “rates” can be associated with a Contact for a given period of time. A contact can have many rates associated with many task items; although there is generally only one rate associated for a specific task in the same period of time. Once the rates are established, when the contact is adding a task or a line item the rate associated with the task will automatically populate the rate area of the records. The automatic population of the rates provides ease of data entry and eliminates any possible data mistakes or errors. As shown in FIG. 19B, to add a task rate and related information, the user need only click an Add button 1925, select a task from a Task Pull-Down List 1930 and enter the rate in dollars and cents in Rate Field 1935. Dates can also be entered in “From” and “To” Date Fields 1940a, 1940b. To modify a Task Rate, the user can select one of a plurality of check boxes 1945, and click an edit button 1950.

“Relation” generally refers to any relationship a Contact has with any other Contact. A Contact can have multiple relationships with other Contacts as well as multiple relations with the same Contact, as shown in FIG. 19C. To add a relation, the user clicks an “Add” button 1955, finds and selects a Contact for which a relation is to be created, and selects the Relation Type from a Relation Pull-Down List 1960. The Direction of the Relationship can also be chosen

As shown in FIG. 19D, the user can associate one or more Territories to a Contact. A Territory is where a Contact Operates. A Contact can have more than one Territory. An add button 1965 can be clicked to begin adding territories, and a Territory selected from a New Territory Pull-Down List 1970.

In FIG. 19E, a Contact Involvement screen 1900e displays all of the projects a contact is involved in. As contacts are added to project records this tab automatically displays their involvement. The Involved Projects can be displayed according to Project Application 1975, Project Name 1980, and Role 1985. By default, (Any) will be displayed in a “Show Involved Project For” pull-down list 1990. “Any” means display all of the Projects in all of the Applications that this Contact is involved. The user can select a specific Application to view the Projects that the Contact is involved with by selecting the Application from the “Show Involved Project For” pull-down list. Contacts can as easily be modified and deleted, as will be understood by the skilled artisan.

Appointments

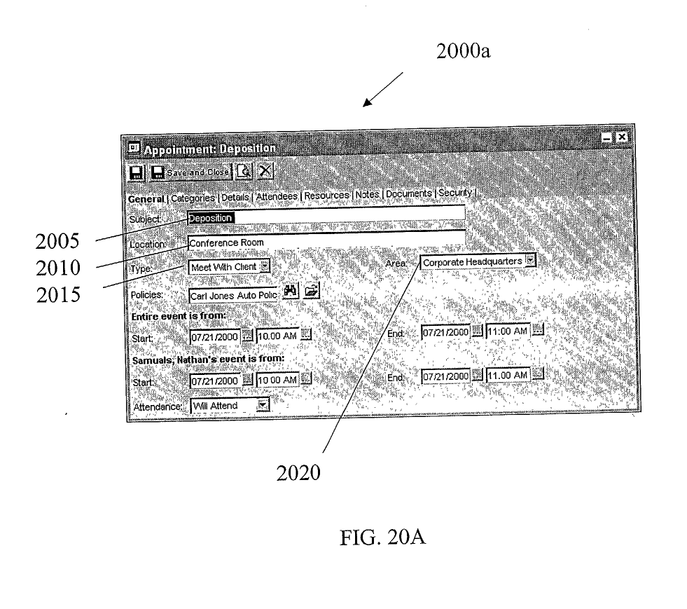

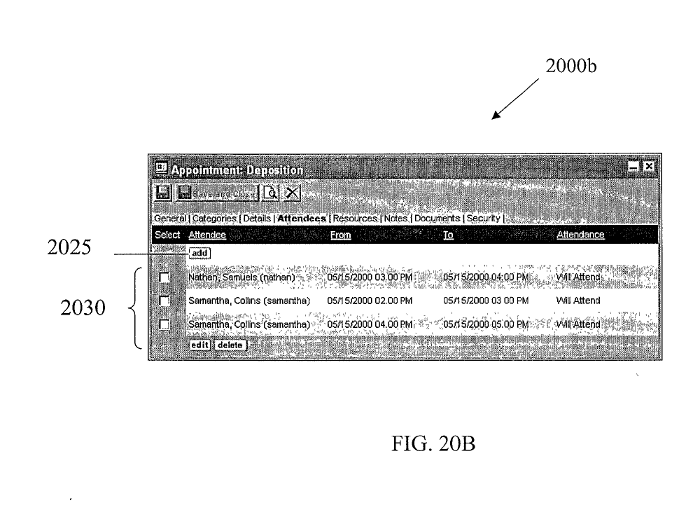

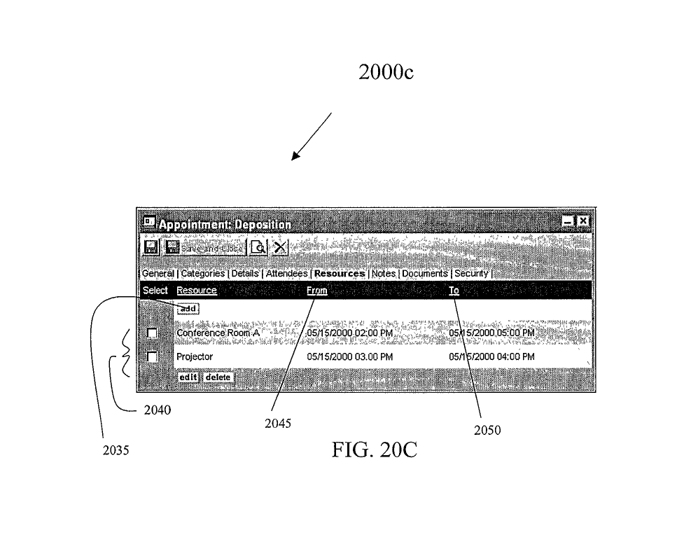

An Appointment Object contains appointments added in the platform. An appointment may be added by going to the appointment object of the menu bar in FIG. 7. Appointments can also be added independent of a project. FIG. 20A shows an Appointment General Tab 2000, with which an Appointment can be created for a user. Also, a Group Appointment can be created with multiple Attendees and Resources. An appointment can also be associated with a Project. The following table summarizes the Fields of the Appointment Object.

| Fields | Description |
|---|---|
| Subject | This field is the Name/Subject of the |
| 2005 | Appointment. |
| Location | This is the Appointment Location. An |
| 2010 | example of a location is Conference Room; |
| | it is the exact location of the |
| | Appointment, unlike Area, which is the area |
| | where the appointment will be, for example, |
| | Corporate Headquarters. |
| Type | Type is the Default Appointment Category; |
| 2015 | this field is linked to the Default |
| | Category field in Categories Tab. |
| Area | This is where the Appointment will be held. |
| 2020 | |
| Project | This is the Project associated with the |
| (i.e. | Appointment. |
| QCCases) | |

Time & Date of the Appointment

By default, the Time & Date will display the Time & Date
when the user clicked New Appointment.
The user can either select the Time & Date from the Popup
Windows corresponding to the Field, or enter the Time &
Date in the Field manually.

User's Event Is From
(Example, David, John (john)'s Event Is From)

| | |
|---|---|
| Start (Date & | This is the Start Date & Time for the |
| Time) | Appointment. |
| End (Date & | This is the End Date & Time for the |
| Time) | Appointment. |

Entire Event Is From

| | |
|---|---|
| Start (Date & | This is the Start Date & Time for the |
| Time) | Entire Event. |
| End (Date & | This is the End Date & Time for the |
| Time) | Entire Event. |

An Appointment Attendees tab 2000b is shown in FIG. 20B. By default, the user will be the Attendee of any Appointment he creates. A Group Appointment can be created by selecting Multiple Attendees. To add multiple attendees, the user clicks an “Add” button 2025. One of a plurality of users 2030 is selected. Start Date & Time is entered, and then End Date & Time in the appropriate fields. The Attendance Type is then selected. After adding a new attendee, the fields are automatically populated with the values just added. Attendees can be freely modified and deleted, as will be understood by the skilled artisan.

An Appointment Resources Tab 2000c is shown in FIG. 20C. Resources are items desired for the Appointment (i.e. Conference Room, Projector, etc.). Like Attendees, Resources can be set up for any time frame of the Appointment. For example, the user can have an Appointment from 9 am until 5 pm, and add a Resource (Projector) from 12 pm until 3 pm. To add a resource, the user clicks an “Add” button 2035, selects an appropriate resource 2040, selects a Date & Time frame (“From” 2045 and “To” 2050), and clicks Add button 2035. Resources can be freely modified and deleted as will be understood by the skilled artisan. To create a new appointment, the user clicks an Appointment Menu in FIG. 7 and selects “New Appointment” from the Popup Menu. The General Tab, shown in FIG. 20A, will display for the user to enter the Subject and Location. An Appointment Type can then be selected.

Task Objects

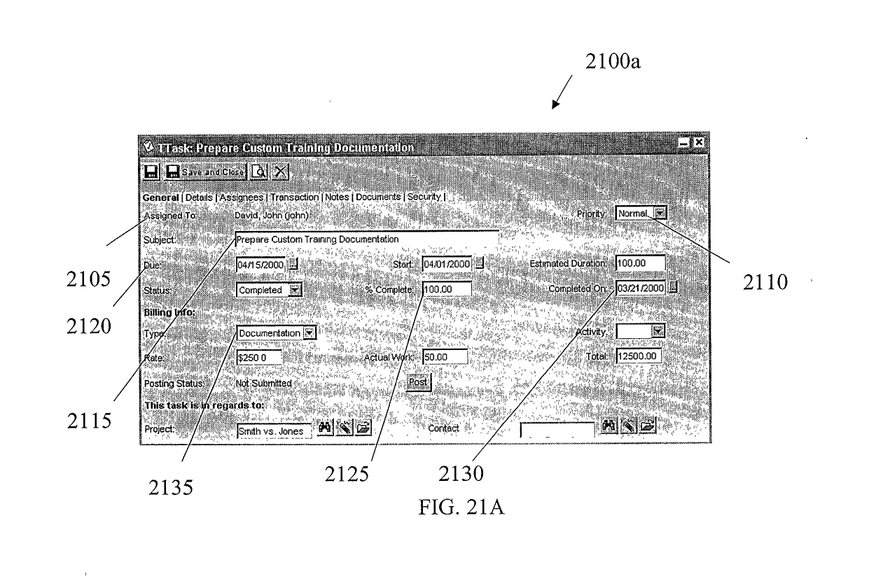

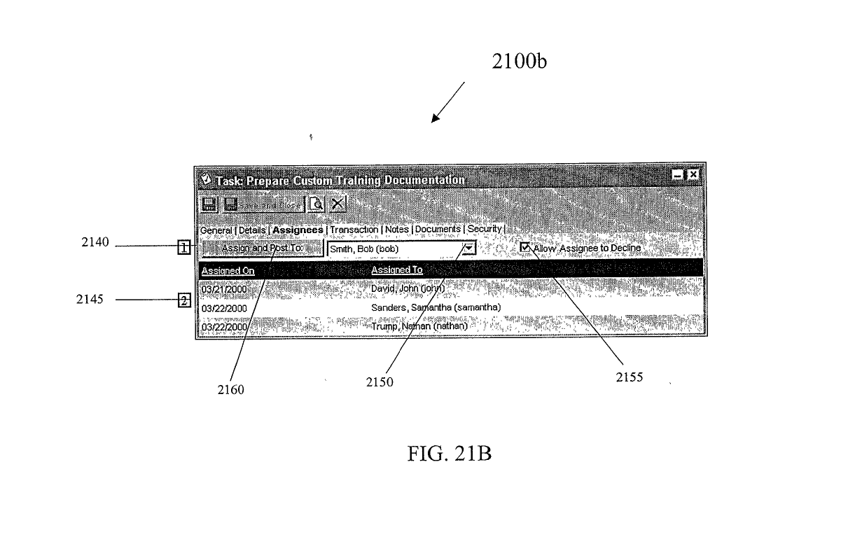

FIG. 21A shows a graphical user interface 2100a representing a Task General Tab. Tasks are action items or activities that are set up for a user for a project or for a user independent of a project. Working with tasks allows the user to keep track of the time required to complete the task activity or action. Once a task is completed, it may be posted to the appropriate account. The following table summarizes the available fields shown in FIG. 21A.

| Field | Description |
|---|---|
| Assigned To | The User who the Task is assigned to. |
| 2105 | |
| Priority | Priority given to the Task: |
| 2110 | Highest |
| | High |
| | Normal |
| | Low |
| | Lowest |
| Subject | Description of Task activity |
| 2115 | |
| Due | Task Due Date. |
| 2120 | |
| Start | Task Start Date. |
| Estimated | Estimated Time (Hours.Minutes) to do a |
| Duration | specified task. |
| The following three fields (Status, % Complete and | |
| Completed On) are linked to one another. | |
| 1. Status | |
| When the user selects “Completed” in the Status | |
| pull-down list, % Complete will display “100%” and | |
| the Completed On will display the “Date” selected | |
| as “Completed” in Status. | |
| 2. % Complete | |
| Once the user enters “100” in % Complete, the | |
| Status will display “Completed” and Completed On | |
| will display the “Date” entered. | |
| 3. Completed On | |
| Once the user enters the “Date” in Completed On, | |
| the Status will display “Completed” and % Complete | |
| will display “100%”. | |
| Status | Status of the Task: |
| | Not Started |
| | Started |
| | Completed |
| % Complete | Percentage of the Task that is currently |
| 2125 | complete. |
| Completed | Date the Task has been completed. |
| On | |
| 2130 | |
| Type | Pull-down item also is able to populate the |
| 2135 | rate field for time tracking purposes. |
| The following three fields (Rate, Actual Work and Total) | |
| are linked to one another. | |
| Rate × Actual Work = Total | |
| The Total field is automatically calculated when the Rate | |
| and Actual Work are populated. | |
| Rate | Rates can be added manually or they can |
| | automatically display by selecting the task |
| | type. |
| Actual Work | Actual Work is the Actual Time |
| | (Hours.Minutes) spent to complete this |
| | Task. |
| Total | Total is the Total Price (Rate × Actual |
| | Work) charged to complete this task. |
| Activity | This is the Task's Activity Type. |
| Posting | This field displays whether the Task has |
| Status | been posted to a Budget. |
| | Not Submitted |
| | Posted |
| | Not Posted |
| | Submitted For Approval |
| Post | This button posts the Task to the |
| | associated Account. |
| Project | If a Task is associated with a |
| and/or | Project/Contact, then the Project/Contact |
| Contact | can be selected. This will display the |
| | Find Project Module or Find/Add Contact |
| | Module, where the user can search for a |
| | Project/Contact and associate it to this |
| | Task. |

A Task Assignee Tab is shown in FIG. 21B. The user is generally assigned to the task he has created; however, he may change the assignment and reassign the task to another user. The Assignee Tab is divided into two sections: a Top Section 2140 allows the user to assign the Task to another User, and a Bottom Section 2145 displays the History of Users who have been assigned to the Task. To assign a task, a User is selected from a Pull-Down List 2150. An “Allow Assignee To Decline” option 2155 is enabled or disabled. An “Assign and Post” button 2160 can then be selected.

A new task record is created by clicking the task menu in FIG. 7 and selecting New Task from the Popup Menu. In FIG. 21A, the Task General Tab 2100a is displayed. The fields summarized in the table above can then be completed. Tasks can be freely deleted and modified, as will be understood by those skilled in the art.

History

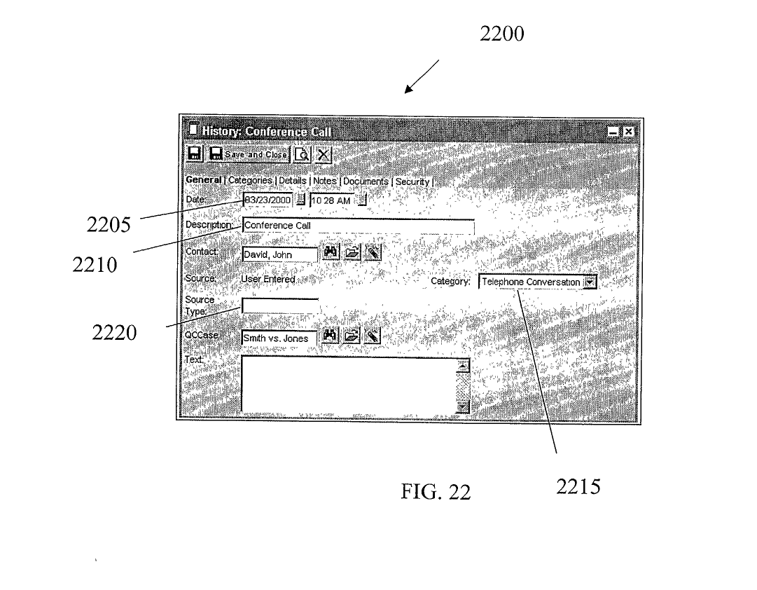

A History Menu allows the user to make a Journal Entry. History records can be created one of two ways: manually entering the History Record, or automatic generation by the Rule Engine. FIG. 22 shows a History General Tab 2200, generated as a graphical user interface. The fields in History General Tab 2200 are summarized in the following table.

| Field | Description |
|---|---|
| Date | Date and Time the History was Created. |
| 2205 | |
| Description | History Description. |
| 2210 | |
| Source | This field automatically populates the |
| | Source of the Entry, whether it is: |
| | User Entered |
| | A User manually created the History |
| | record. |
| | Object (Project, Contact, Task, |
| | Appointment, etc.) |
| | Automatically generated by the Rule |
| | Engine and the source was either Project, |
| | Contact, Task, etc. |
| Category | This field displays the Default History |
| 2215 | Category. This field is linked to the |
| | Default Category field in Categories Tab. |
| Source Type | Additional text entry field for specifying |
| 2220 | the source of the history. |
| Project | This field associates the History to a |
| | Project. |
| Contact | This field associates the Expense to a |
| | Contact. |

To manually create a new history record, the user Clicks the History Menu in FIG. 7 and selects New History from a Popup Menu. The History General Tab 2200 will display. The Date and Time fields will be automatically populated, and can then be modified. A description can then be entered. The Contact field will be populated with the user's Last Name, First Name. The user can click the Find button to change the Contact information. The Source will automatically be populated according to how it has been created, either Manually (User Entered) or Rule Generated (Project, Contact, Task, etc.). The Category field will have Root populated until more categories are added in the Categories Tab. The Category pull-down list will dynamically be populated as history categories are added from the Categories tab. Data can be entered in other fields as desired. History records can be freely modified and deleted.

Expenses

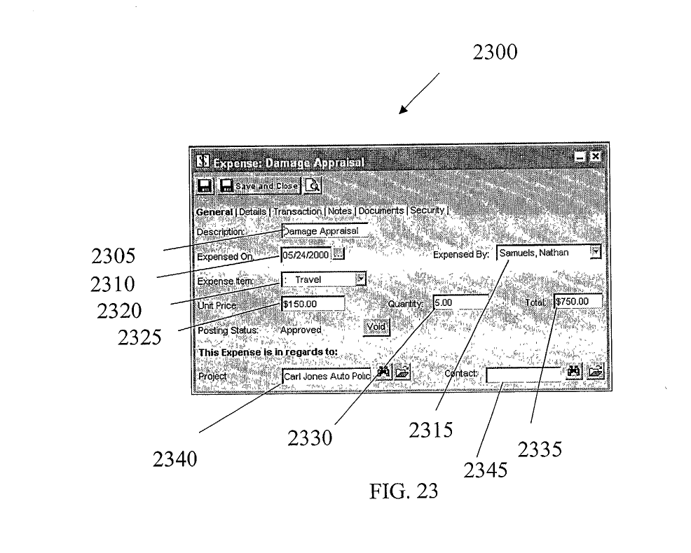

An Expense is the cost of merchandise bought or costs associated with the services rendered. An expense can be associated to a Project Record or it can be a general expense not associated to a Project Record. An Expense can also be posted to an Account using the Post button, when an Account has been set up. FIG. 23 shows a graphical user interface 2300 presenting an Expense General Tab. The fields in the General Tab 2300 are summarized in the following table.

| Fields | Description |
|---|---|
| Description | Description of the Expense. |
| 2305 | |
| Expensed On | Date the expense is for or the date the |
| 2310 | record was added. |
| Expensed By | This is the User who is either entering or |
| 2315 | submitting the Expense. |
| Expense Item | The Expense Type |
| 2320 | |
| Unit Price | Price per Unit (Item) for Merchandise. |
| 2325 | -OR- |
| | Price per Hour for Service Rendered. |
| Quantity | Total Quantity (Items) of Merchandise. |
| 2330 | -OR- |
| | Total Hours and Minutes of Services |
| | rendered. |
| Total | Total = Quantity × Unit; this is |
| 2335 | automatically calculated. |
| Project | This field associates the Expense Record |
| 2340 | to a Project. |
| Contact | This field associates the Expense Record |
| 2345 | to a Contact. |
| Posting | Posting Status refers to the Post button |
| Status | explained below. |
| | Not Submitted - Not clicked the Submit |
| | for Approval button. |
| | Submitted - Clicked the Submit for |
| | Approval button. |
| | Approved - Has been posted to the |
| | Account. |
| | An Approved Posting Status means that the |
| | Expense has been allocated towards the |
| | Account as well as set as a Transaction in |
| | the Account (Account: Transaction Tab). |
| “Post” | This button allows the User to Post the |
| Button | Expense Record to an Account Record. |
| “Void” | This button allows the user to Void the |
| Button | Expense Record from the Account. This |
| | means that the Transaction will be voided |
| | from the Account Record and subtracted |
| | from the Allocation Amount of the Account |
| | Record. |

Account

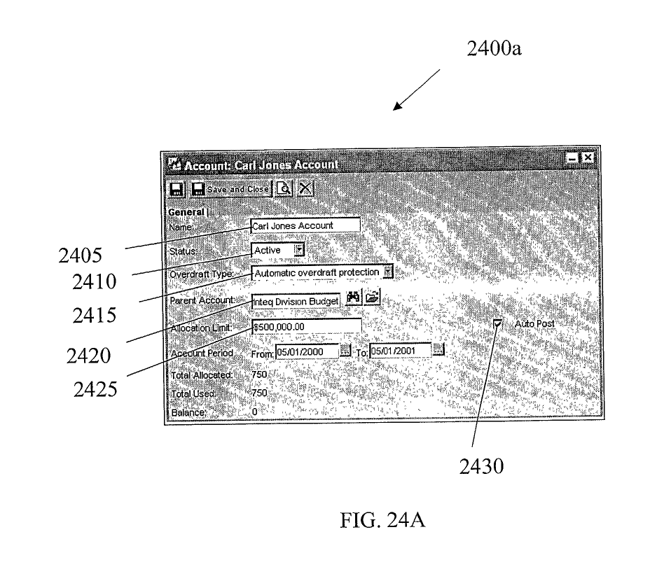

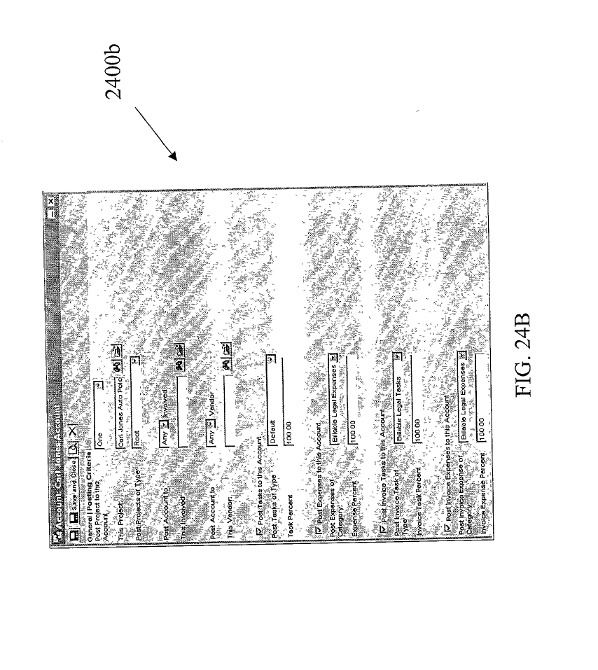

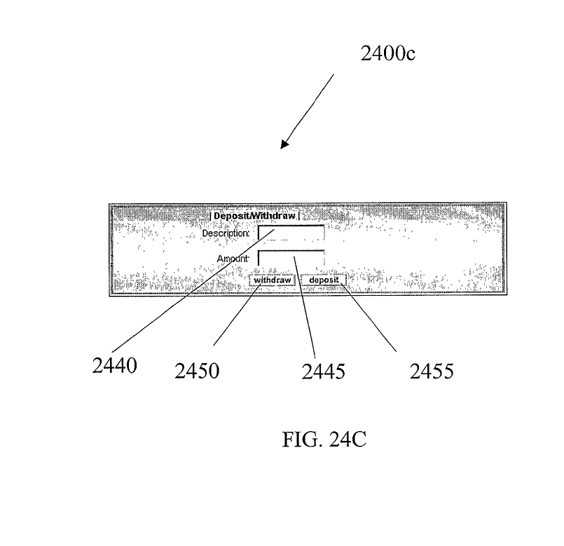

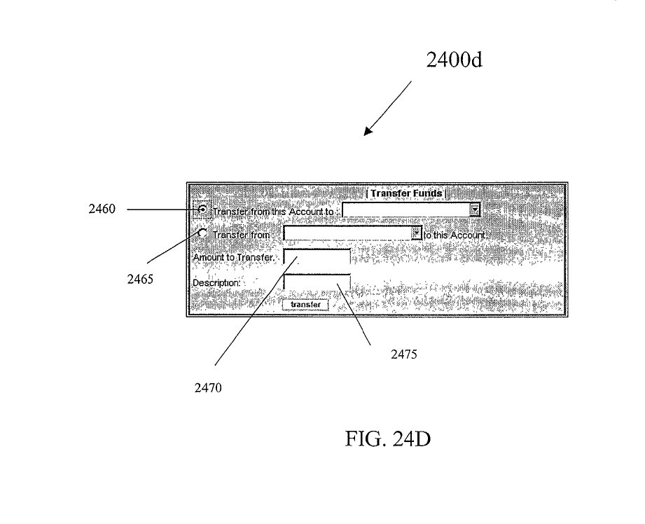

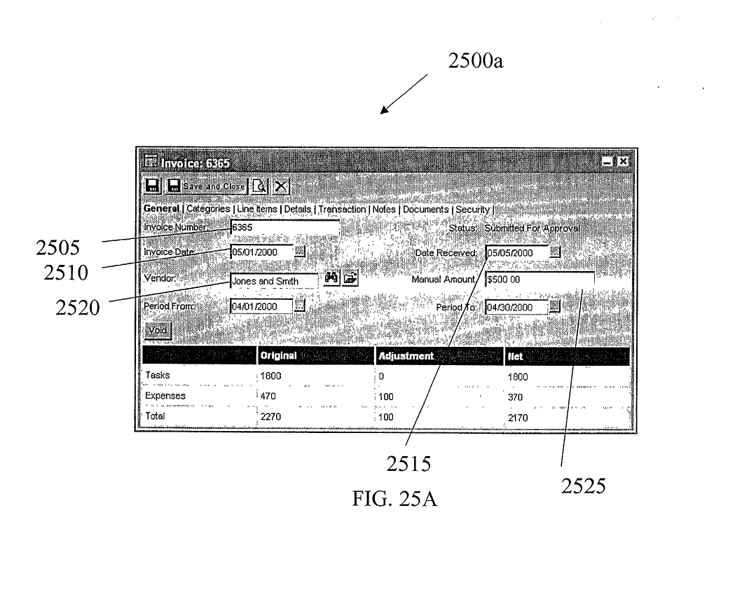

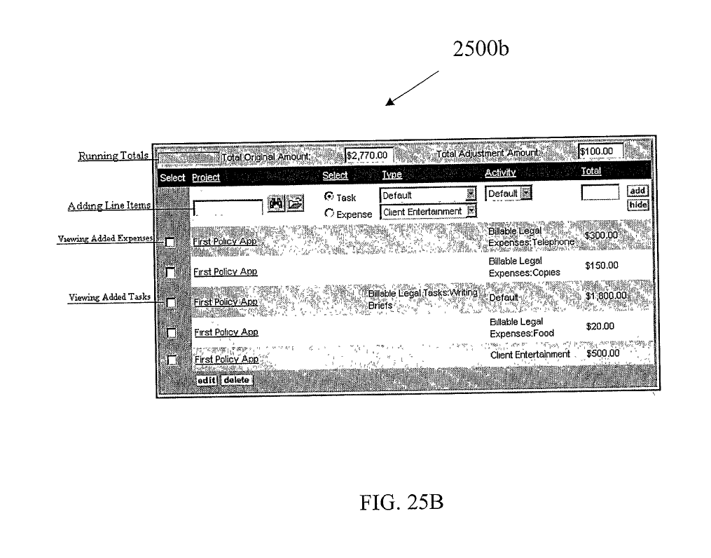

The account object allows the user to set up charge back strategies and posting criteria. This object allows for creating parents and children accounts, reserves and conditions to which tasks, expenses, and invoices should be posted. An exemplary graphical user interface presenting an account tab 2400a is shown in FIG. 24A. The fields in tab 2400a are summarized in the following table:

| Field | Description |
|---|---|
| Name | Name of Account, for purposes of Report |
| 2405 | Writing, Document Generator and Search. |
| Status | Status of Account: |
| 2410 | Active |
| | Inactive |
| Overdraft | Do Not Allow Negative Account |
| Type | Once the allocated amount of account |
| 2415 | has been met, no other transactions |
| | can take place if this option is |
| | selected. |
| | Allow Negative Account |
| | If the allocation amount has been |
| | met, selecting this option will allow |
| | posting of transactions to continue |
| | showing a negative amount in the |
| | Balance field. |
| | Automatic Overdraft Protection |
| | This is available when there is a |
| | Parent Account. This will |
| | automatically take the necessary |
| | funds from the Parent Account to the |
| | Child Account so that the Transaction |
| | can be posted. |
| Parent | Parent Account of the following Account |
| 2420 | Record. |
| Allocation | Limit Allocated for this Account. Once |
| Limit | this limit has been met, the platform |
| 2425 | will allow postings of the transactions |
| | according to the Overdraft Type |
| | selection. |
| Auto Post | Automatically post all transactions to |
| 2430 | the Account Record. Auto Post is |
| | linked to the Account For section. In |
| | this section the user can specify which |
| | Object Records can be automatically |
| | posted to the Account Record. |
| Account | Time period allowing postings of |
| Period | transactions. |
| Total | Displays the Total Amount Allocated. |
| Allocated | This amount is the sum of all of the |
| | deposited funds from the |
| | Deposit/Withdrawal and Transfer Funds |
| | tabs. |
| Total Used | This is the Total Amount of |
| | Transactions that have posted or |
| | withdrawals that have manually been |
| | entered against the Account Record. |
| Balance | This is the difference of Total |
| | Allocated Amount from Total Used |
| | Amount. |
| | Balance = Total Allocated − Total |
| | Used |

FIG. 24B shows a tab 2400b that pertains to the Auto Post check box. Once Auto Post is enabled (checked), the user then selects the criteria so that the correct Transactions are automatically posted to the Account Record. The table below summarizes the features in FIG. 24B.

| Field | Description |
|---|---|
| Project | Post Project to this Account: |

1) Any
This will automatically post any
project with the specified
criteria below (Task, Expense,
Involved, etc.) to the Account.
2) One
This will automatically post a
specific Project Record and its
specified criteria below to the
Account Record.
3) By Type
This will automatically post all
Project Records of a specified
type and its specified criteria
below to the Account Record.
4) By Custom Type (currently not
available)
This Project
This is linked to the Post Project to
this Account pull-down list.
Post Projects of Type
This is linked to the Post Project to
this Account pull-down list.
Project Categories work in a
Hierarchical Order; the following is
an example of this order:
Root

Case

Personal Injury
Property Damage

Auto
Building

Third Party Injury

Claims

| | With a Hierarchy Structure, a |
|---|---|
| | Transaction will be automatically |
| | posted for the item and its sub-items |
| | in any Project Record. For example, |
| | if Root is selected, then Root and |
| | all the items in the Post Projects of |
| | Type table will be included. This |
| | means that any Project Type or |
| | Category with the specified criteria |
| | below will automatically be posted to |
| | the Account Record. |
| Involved | Post Account to Involved |
| | 5) Any |
| | This means Any Involved |
| | pertaining to the Specified |
| | Project Criteria will be posted. |
| | 6) One |
| | This means that only the |
| | Specified Involved pertaining to |
| | the Specified Project Criteria |
| | will be posted. |
| | This Involved |
| | Find and Select the Involved. |
| Vendor | Post Account to Vendor |
| | 7) Any |
| | This means Any Vendor pertaining |
| | to the Specified Project |
| | Criteria will be posted. |
| | 8) One |
| | This means that only the |
| | Specified Vendor pertaining to |
| | the Specified Project Criteria |
| | will be posted. |
| | This Vendor |
| | Find and Select the Vendor. |
| The following items will be enabled (checked) for them | |
| to be automatically posted to the Account Record. | |
| Tasks, | Post (Tasks, Expenses, Invoice Tasks, |
| Expense, | or Invoice Expenses) to this Account |
| Invoice Task | The user checks to Enable or leaves |
| and Invoice | blank to Disable. If blank, skip |
| Expense | Post * of Type and * Percent. |

Post * of Type/Category
This is linked to the Post * to this
Account check box. Once the check
box is enable (checked), the user can
select the * Type or Category from
this pull-down list.
* Types or Categories work in a
Hierarchical Order. The following is
an example of Expense Category:
Billable

Copies
Telephone
Travel
Food
Entertainment

Non-Billable
With a Hierarchy Structure, a
Transaction will be automatically
posted for the item and its sub-items
in any Expense Record. For example,
if Billable is selected then Billable
and all of the items below Billable
will be included, except Non-Billable
becomes Billable and Non-Billable are
on the same Level.
* Percent
Percent is the Percent of the Total
Amount of the Transaction that will
be posted to the Account Record. For
example, if the user enters 50, then
50% of the Total Amount of the Task,
Expense, Invoice Task or Invoice
Expense Record will be posted to the
Account Record.

FIG. 24C shows a Deposit/Withdraw Tab 2400c. This tab allows manual deposits to and withdrawals from an Account Record. When a user manually enters a Deposit or Withdraw, a Transaction will be created in the Transaction Tab as well as the Amount in Total Allocated (Deposit). Total Used (Withdraw) in the Account Record's General Tab will be affected. To deposit or withdraw funds, the user can enter a Description 2440 pertaining to a Transaction. The user then enters an Amount in field 2445, and clicks either Deposit 2450 or Withdraw 2455.

As shown in FIG. 24D, funds can be transferred from a Parent Account Record to a Child Account Record or vice versa. The transferred funds are displayed in the Transaction Tab and will affect the Amounts (Allocated, Used and Balance) in the General Tab. The fields shown in FIG. 24D are summarized in the following table.

| Field | Description |
|---|---|
| Transfer from | This selection will withdraw from the |
| this Account to | Account Record to the selected Account |
| | Record. |
| 2460 | The pull-down list will display the |
| | Current Account Record's Parent and |
| | Child Account Records. |
| Transfer from | This selection will deposit to the |
| to this | Account Record from the selected |
| Account | Account Record. |
| 2465 | The pull-down list will display the |
| | Current Account Record's Parent and |
| | Child Account Records. |
| Amount to | This is the Amount Transferring to or |
| Transfer | from the Current Account Record. |
| 2470 | |
| Description | A Description for the Transfer. |
| 2475 | |

In FIG. 24D, to transfer funds, the user selects whether “Transferring From,” Radio Button 2460 or “Transferring To,” Radio Button 2465, the Current Account Record. The user selects the Account Record to Transfer To or Transfer From, from the corresponding pull-down lists. An Amount to Transfer is entered in field 2470. A Description pertaining to the Transfer (optional) can be entered in field 2475. A “Transfer” button 2480 is then selected.

Accounts

A “Child Accounts” tab allows a user to create and view Child Account Records pertaining to an Account Record. When creating a new Child Account, a New Account Record will be created with the Parent Account field automatically populated with the Account Record from which the child account record was created. Information including the Name of the Account, Active/Inactive Status, and Overdraft Type can be entered. Other relevant information includes the Account Period and Allocation Limit. Account records can be freely modified or deleted.

Invoice Objects

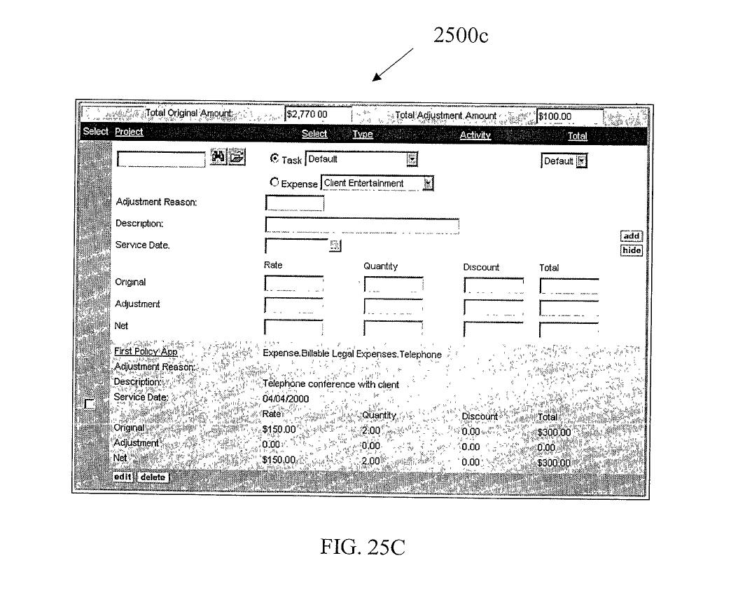

An Invoice is a bill prepared by a seller of goods or services and submitted to the buyer. In Invoice, the user can record the Invoice and include each item included in the Invoice. An Invoice General Tab is shown in FIG. 25A. The following table summarizes the fields in FIG. 25A.

| | |
|---|---|
| Field | Functionality |

| Invoice | Invoice Number | |
|---|---|---|
| Number | | |
| 2505 | | |
| Invoice Date | Date Invoice was Issued | |
| 2510 | | |
| Date | Date Invoice was Received | |
| Received | | |
| 2515 | | |
| Vendor | Name of Vendor (e.g., a Contact) | |
| 2520 | | |
| Manual | Amount manually entered for the Invoice | |
| Amount | | |
| 2525 | | |
| Period From | Time Frame the Invoice is Covered | |
| & Period To | | |
| Posting | Posting Status refers to the Post button | |
| Status | explained below. | |
| | Not Submitted - Not clicked the Submit | |
| | for Approval button. | |
| | Submitted - Clicked the Submit for | |
| | Approval button. | |
| | Approved - Has been posted to the | |
| | Account. | |
| | An Approved Posting Status means that the | |
| | Invoice has been allocated towards the | |
| | Account as well as set as a Transaction in | |
| | the Account (Account: Transaction Tab). | |
| “Post” | This button allows the User to Post the | |
| Button | Invoice Record to an Account Record. | |
| “Void” | This button allows the user to Void the | |
| Button | Invoice Record from the Account. This | |
| | means that the Transaction will be voided | |
| | from the Account Record and subtracted from | |
| | the Balance of the Account Record. | |
| | The items below are linked to Line Items | |
| | Tab. These are the Total Original, | |
| | Adjusted and Net Amounts of all Expenses | |
| | and Tasks entered for the Invoice Record. | |
| | Tasks | Displays the Total for all Tasks |
| | | for the Invoice Record. It |
| | | displays the Total: |
| | | Original Amount (Gross |
| | | Amount) |

| | |
|---|---|
| | Adjustment Amount (in |
| | dollars) |
| | Net Amount (Original - |
| | Adjustment) |
| Expenses | Displays the Total for all |
| | Expenses for the Invoice Record. |
| | It displays the Total: |
| | Original Amount (Gross |
| | Amount) |
| | Adjustment Amount (in |
| | dollars) |
| | Net Amount (Original |
| | Adjustment) |
| Total | The Last Row Displays the Total |
| | for each Column. It displays the |
| | Total for: |
| | Original Amount (Gross |
| | Amount) |
| | Adjustment Amount (in |
| | dollars) |
| | Net Amount (Original - |
| | Adjustment) |

Invoice Line Items are generally displayed in two fashions. A Concise View, shown in FIG. 25B, has minimal information to add a line item, while an Expanded View, shown in FIG. 25C, provides additional fields to capture the line item information in greater detail.

Documents

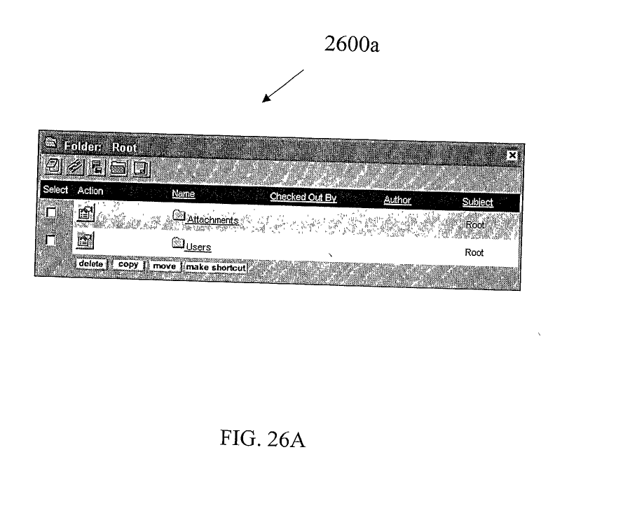

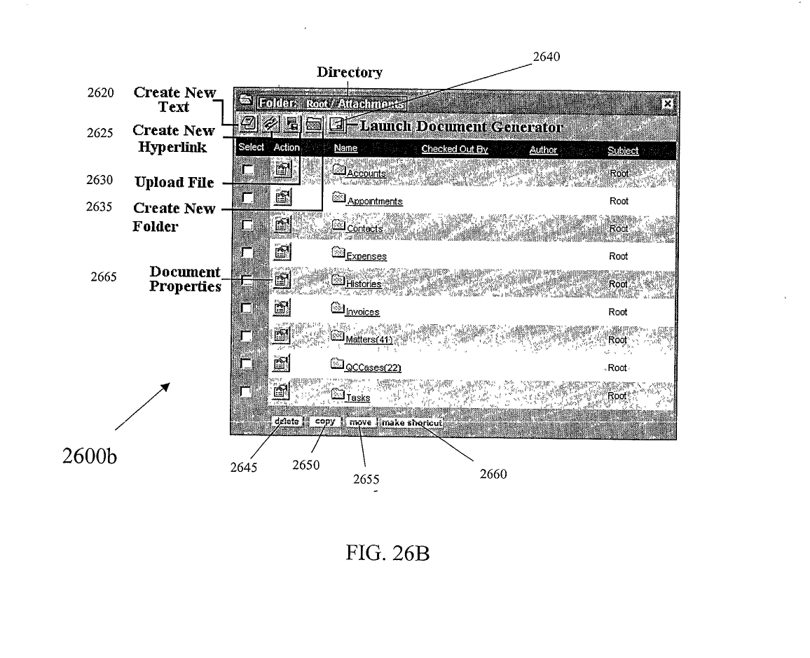

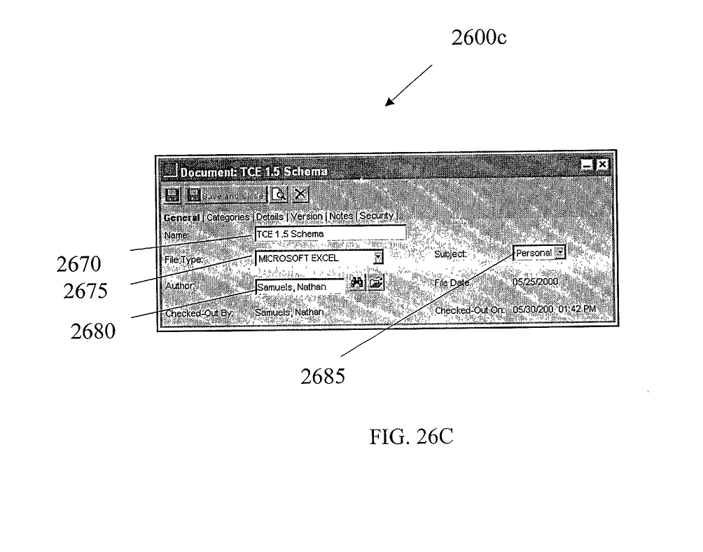

A Documents folder contains files that have been submitted or attached by a User, as shown in FIG. 26. By default, a Documents Menu will generally have the following folders:

I. Root

A. Attachments

Objects
(1) Accounts
(2) Appointments
(3) Contacts

Example: John Smith
Example: Carol Chow

(4) Expenses
(5) History
(6) Invoices
(7) Project (Name of the Specific
Project)

(a) Account

(i) Involved
(ii) Milestone

(b) Location

(8) Tasks

B. Users

(1) Example: Thomas Callahan
(2) Example: Jane Flanagan

Once records have been added, the corresponding document folder will be automatically created in the document object.

In FIG. 26B, a “Create New Text” button 2620 will display a General Screen providing information on the text document. The button 2620 also has its own tabs to create and store additional information about a text document. A “Create New Hyperlink” button 2625 links to a Window where the user can enter a URL to a website for Users to access. An “Upload File” button 2630 provides the ability to add an existing document to the platform. A “Create New Folder” button 2635 opens a Dialog Box where the user can create a new folder. A “Launch Document Generator” button 2640 links to a “Document Generator Screen,” where letters can be generated from listed Templates.

In FIG. 26B, in a documents list view, the user may perform the following operations upon selecting one or more documents by clicking a check box next to the desired document(s). “Delete” 2645 deletes the selected files or folders; “Copy” 2650 copies a selected document into a new location; “Move” 2655 moves the selected document to a new location (generally no copy remains in the original directory); and “Make Shortcut” 2660 creates a link to an existing document.

Documents can be posted by: (1) submitting a file from the Documents Menu, and (2) accessing the Object Record by clicking the Document tab and directly working within the Object Record. Other Fields shown in FIG. 26B are summarized in the following table.

| Fields | Description |
|---|---|
| Headers | Files can be sorted alphabetically in |
| | ascending or descending order by Name, |
| | Checked Out By, Author or Subject. |
| Current | Displays the location in the Directory. |
| Folder | |
| Select | The user can select one or more check |
| | boxes corresponding to the File or Folder |
| | to Delete, Move, Copy, or Create |
| | Shortcut. |
| Action | There can be one or more buttons |
| | displayed in this area at one time: |
| | Properties |
| | Check In |
| | Check Out |
| | Undo Check Out |
| Properties | The Properties Button 2665 will link to |
| | the General screen for the document |
| | profile and ability to access additional |
| | information on the document by clicking |
| | on the available tabs. |
| Check Out | Checks Out the File for the user to view |
| | and modify. |
| Check In | Checks In the File that has been checked |
| | out. |
| Undo Check | Will Undo the Check Out. |
| Out | |
| Name | Displays the hyperlink File or Folder |
| | Name. |
| Checked Out | Displays hyperlink to the User's Contact |
| By | Information. This is the User who has |
| | last checked out the file. |
| Author | Displays the Author's Name (Contact Name |
| | Hyperlink). |
| Subject | Displays the Document's Subject. Subject |
| | might vary, but Subject can be an |
| | Assignment, Contract, Draft, etc. |

A Documents General Tab will open and, by default, certain fields will be automatically populated:

| | |
|---|---|
| File | TEXT will automatically be populated in |
| Type | the pull-down list. This enables the |
| | Scroll Text field to display; by |
| | selecting another File Type will |
| | disable the Scroll Text field. |
| Subject | Select a subject for the text document |
| Author | Last Name, First Name |
| Date | Date will automatically be populated |
| | until the user manually enter or select |
| | another date from the Popup Calendar. |

Files can be attached, hyperlinks submitted, and folders created as desired.

A Document also has properties containing specific information regarding the Document, as shown in FIG. 26C. A General Tab lists a plurality of fields, summarized in the following table.

| | |
|---|---|
| Name | Name of the Document or Folder. |
| 2670 | |
| File Type | The Application for which the Document |
| 2675 | was created with (i.e. Microsoft Word, |
| | Lotus Word Pro, etc.). |
| Author | Contact who submitted or created the |
| 2680 | document. |
| Subject | Subject of the document available |
| 2685 | through a pull-down list. |
| Date Authored | Date document was added or attached to |
| | the platform. |
| Checked-Out | User's Contact Last, First Name who |
| By | has currently checked out the |
| | Document. This will display if a |
| | Document is Checked Out. |
| Checked-Out | Date the document has last been |
| On | checked out. This will only display |
| | if a Document is Checked Out. |

Platforms provided in accordance with exemplary embodiments of the present invention allow a user to create document templates such that data entered on various screens and objects can be merged. Documents can be generated based on the entered information. In one example, a form letter is generated and sent to an insured individual and his lawyer. The Programming Language XML can be used to generate letters, among other documents, quickly and easily. Documents can be generated from within a record.

The platform described above provides a combination of expertise and technology for transforming the intellectual assets of a company into business value and increasing that business value as knowledge is generated and incorporated. This knowledge management process transforms cost centers into result centers. An organization's collective knowledge is harvested and shared to achieve results in productivity and innovation. These solutions facilitate a collaborative management discipline to make employees more knowledgeable, more innovative and better decision makers. Clients are better served by having the collective expertise leveraged on their behalf.

The platform described above provides an organizational level strategy to systematically cross corporate knowledge boundaries. The platform provides a middle-tier to accommodate diversified business logic, a flexible application architecture, and an adaptable integration infrastructure. Employees and ideas are brought together across boundaries of time, geography, and organizational structure. The employees can brainstorm, share and create new ideas, discover and mine corporate knowledge that has already been created and stored.

The platform described above features a robust and scalable application-serving environment capable of hosting multiple integrated applications for various units of an organization. Each unit may have specialized applications geared for its purpose while remaining integrated with the rest of the organization. The platform is particularly applicable to Legal, Insurance, Risk industries, including:

Corporate Legal

Government Legal

Corporate Secretary

Claims

Claims Litigation

Risk Management

Loss Control

Negligence Assessment

Third Party Administration

Worker's Compensation

Example

In one example, a claim representative at an insurance company receives a phone call from an insured person. This person communicates his policy number describes an accident, and relays any additional information.

The claim representative uses the policy number to identify the policy for the insured. For that policy, the representative creates a new child claim. The representative then inputs information for the new claim, for example, a description of accident site. Other information may be required, including the geographical location of the accident, and the nature of the accident (e.g., was bodily injury involved?).

A business rule (already programmed before receiving the call) is then triggered to apply some local state laws to the object. This is an example of custom business logic tied to the new object definitions. For example, personal injury rules in California mandate that a claim must be filed within a certain number of days.

As the claim moves into the litigation department of the Insurance Company, the claim is transitioning between phases. Business rules can be automatically generated that create work for attorneys, paralegals, etc. For instance, as a claim moves through litigation there is often a discovery phase, pre-trial motions phase, trial phase, etc. Business rules can be triggered at each of these phases.

Exemplary embodiments of the platform described above support Oracle, IBM DB2, and Microsoft SQL Servers, among others. Additionally, the platform supports ODBC compliant databases. The platform can run on any suitable server operating system including Solaris, HPUX, Windows NT, and Mac OS X Servers. The platform can be realized on any suitable Web server, e.g., a CGI compliant Web server such as Apache, Microsoft IIS, and Netscape/iPlanet servers. The platform supports any operating system running a suitable browser such as Netscape Navigator or Microsoft Internet Explorer, including Windows 95/98/NT/2000, Unix, Linux, and Mac. In one exemplary embodiment, the platform is implemented as a Web application with access provided through a JavaScript capable browser such as Microsoft Internet Explorer 4.01 or higher or Netscape Navigator 4.73 or higher.

FIG. 27 is a block diagram of a computer system 2700 used to provide a platform constructed according to an exemplary embodiment of the present invention. The computer system 2700 includes a processor 2730 for executing program instructions stored in a memory 2725. In some embodiments, processor 2730 includes a single microprocessor, while in others, processor 2730 includes a plurality of microprocessors to define a multi-processor system. The memory 2725 stores instructions and data for execution by processor 2730, including instructions and data for performing the methods described above. Depending on the extent of software implementation in computer system 2700, the memory 2725 stores executable code when in operation. The memory 2725 includes, for example, banks of read-only memory (ROM), dynamic random access memory (DRAM) as well as high-speed cache memory.

In FIG. 27, within computer system 2700, an operating system comprises program instruction sequences that provide services for accessing, communicating with, and controlling the computer system 2700. The operating system provides a software platform upon which application programs may execute, in a manner readily understood by those skilled in the art. The computer system 2700 further comprises one or more applications having program instruction sequences for performing the methods described above.

In FIG. 27, the computer system 2700 incorporates any combination of additional devices. These include, but are not limited to, a mass storage device 2735, one or more peripheral devices 2740, an audio means 2750, one or more input devices 2755, one or more portable storage medium drives 2760, a graphics subsystem 2780, a display 2785, and one or more output devices 2745. The various components are connected via an appropriate bus 2790 as known by those skilled in the art. In alternative embodiments, the components are connected through other communications media known in the art. In one example, processor 2730 and memory 2725 are connected via a local microprocessor bus; while mass storage device 2735, peripheral devices 2740, portable storage medium drives 2760, and graphics subsystem 2780 are connected via one or more input/output buses.

In FIG. 27, mass storage device 2735 is implemented as fixed and/or removable media, for example, as a magnetic, optical, or magneto-optical disk drive. The drive is preferably a non-volatile storage device for storing data and instructions for use by processor 2730. In some embodiments, mass storage device 2735 stores client and server information, code for carrying out methods in accordance with exemplary embodiments of the invention, and computer instructions for processor 2730. In other embodiments, computer instructions for performing methods in accordance with exemplary embodiments of the invention also are stored in processor 2730. The computer instructions are programmed in a suitable language such as Java or C++.

In FIG. 27, the portable storage medium drive 2760, in some embodiments, operates in conjunction with a portable non-volatile storage medium, such as a floppy disk, CD-ROM, or other computer-readable medium, to input and output data and code to and from the computer system 2700. In some embodiments, methods performed in accordance with exemplary embodiments of the invention are implemented using computer instructions that are stored on such a portable medium and input to the computer system 2700 via portable storage medium drive 760.

In FIG. 27, the peripheral devices 2740 include any type of computer support device, such as an input/output (I/O) interface, to add functionality to computer system 2700. In one example, the peripheral devices include a network interface card for interfacing the computer system to a network, a modem, and the like. The peripheral devices also include input devices to provide a portion of a user interface and may include an alphanumeric keypad or a pointing device such as a mouse, a trackball, a stylus, or cursor direction keys. The I/O interface comprises conventional circuitry for controlling input devices and performing particular signal conversions upon I/O data. The I/O interface may include, for example, a keyboard controller, a serial port controller, and/or digital signal processing circuitry.

In FIG. 27, the graphics subsystem 2780 and the display 2785 provide output alternatives of the system. The graphics subsystem 2780 and display 2785 include conventional circuitry for operating upon and outputting data to be displayed, where such circuitry preferably includes a graphics processor, a frame buffer, and display driving circuitry. The display 2785 may include a cathode ray tube (CRT) display, a liquid crystal display (LCD), or other suitable devices. The display 2785 preferably can display at least 256 colors. The graphics subsystem 2780 receives textual and graphical information and processes the information for output to the display 2785. A video card in the computer system 700 also comprises a part of graphics subsystem 2780 and also preferably supports at least 256 colors. For optimal results in viewing digital images, the user should use a video card and monitor that can display the True Color (24 bit color) setting. This setting enables the user to view digital images with photographic image quality.

In FIG. 27, audio means 2750 preferably includes a sound card that receives audio signals from a peripheral microphone. In addition, audio means 2750 may include a processor for processing sound. The signals can be processed by the processor in audio means 2750 of computer system 2700 and passed to other devices as, for example, streaming audio signals.

In some embodiments, programs for performing methods in accordance with exemplary embodiments of the invention are embodied as computer program products. These generally include a storage medium or media having instructions stored thereon used to program a computer to perform the methods described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card, smart card, and other media.

Stored on one or more of the computer readable media, the program includes software for controlling both the hardware of a general purpose or specialized computer or microprocessor. This software also enables the computer or microprocessor to interact with a human or other mechanism utilizing the results of exemplary embodiments of the invention. Such software includes, but is not limited to, device drivers, operating systems and user applications. Preferably, such computer readable media further include software for performing the methods described above.

In certain other embodiments, a program for performing an exemplary method of the invention or an aspect thereof is situated on a carrier wave such as an electronic signal transferred over a data network. Suitable networks include the Internet, a frame relay network, an ATM network, a wide area network (WAN), or a local area network (LAN). Those skilled in the art will recognize that merely transferring the program over the network, rather than executing the program on a computer system or other device, does not avoid the scope of the invention.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. An object-oriented computer system for managing a plurality of knowledge objects for use by an organization having a plurality of departments, the system comprising:
a memory in which the knowledge objects can be stored; and
an application server in communication with the memory, the application server including:
an object framework layer providing management of communications with the memory, communications with other interface applications and devices, and management of sessions for the knowledge objects;
a business logic layer defining functionalities of and interrelationships between the knowledge objects; and
an interface layer providing an interface for the interface aplications and devices capable of communicating with the application server.

2. The system of claim 1, the application server further comprising:
a security layer capable of permitting and preventing actions by the interface applications and devices on one of the knowledge objects when in communication with the application server.

3. The system of claim 1, the application server further comprising:
an applications programming interface (API) layer providing an interface for an interface application and device to interact with the knowledge objects to generate custom business logic.

4. The system of claim 1, wherein the interface layer is a user interface (UI) layer providing an interface for communication with a device operated by a user.

5. The system of claim 4 wherein the device is a computer with web browser capabilities.

6. The system of claim 4 wherein the device is a personal digital assistant.

7. The system of claim 1, the application server further comprising:
an XML interface module providing an XML interface for a plurality of further systems and a plurality of batch applications to communicate with the application server.

8. The system of claim 7 wherein one of the batch applications is a data import application.

9. The system of claim 7 wherein one of the batch applications is a data export application.

9. The system of claim 7 wherein one of the batch applications is a PDA synchronization application.

10. The system of claim 7 wherein one of the batch applications is an offline application.
